(19) United States
(12) Patent Application Publication
(10) Pub. No.: US 2026/0291670 A1
(43) Pub. Date: Sep. 24, 2026

(54) TECHNIQUES FOR HANDLING UPLINK TRANSMISSION IN A TIME PERIOD ASSOCIATED WITH DOWNLINK COMMUNICATION IN ACCORDANCE WITH A PERIODIC SWITCHING PATTERN

(71) Applicant: QUALCOMM Incorporated, San Diego, CA (US)

(72) Inventors: Jae Ho RYU, San Diego, CA (US); Kazuki TAKEDA, Minato-ku (JP); Hari SANKAR, Poway, CA (US)

(21) Appl. No.: 19/390,310

(22) Filed: Nov. 14, 2025

Related U.S. Application Data
(60) Provisional application No. 63/775,263, filed on Mar. 20, 2025.

(51) Int. Cl. H04L 5/00; H04L 1/1867; H04W 72/1263

(52) U.S. Cl. CPC H04L 5/0044; H04L 1/1896; H04W 72/1263

(57) ABSTRACT

This disclosure provides methods, components, devices and systems for techniques for handling uplink transmission in a time period associated with downlink communication in accordance with a periodic switching pattern. For example, a user equipment (UE) may be configured with a first band that is used for both uplink communication and downlink communication and a second band that is used for downlink communication and a pattern for switching between a first period associated with operation on the first band and a second period associated with operation on the second band. The UE may determine whether to perform, and the network entity may determine whether to monitor for, an uplink transmission in a resource scheduled for uplink transmission that is within an instance of the second period based on the transmission type of the uplink transmission or the resource type of the resource in which the uplink transmission is scheduled.

### CROSS REFERENCE

The present Application for Patent claims the benefit of U.S. Provisional Patent Application No. 63/775,263 by Ryu et al., entitled “TECHNIQUES FOR HANDLING UPLINK TRANSMISSION IN A TIME PERIOD ASSOCIATED WITH DOWNLINK COMMUNICATION IN ACCORDANCE WITH A PERIODIC SWITCHING PATTERN,” filed Mar. 20, 2025, assigned to the assignee hereof, and expressly incorporated by reference herein.

### TECHNICAL FIELD

This disclosure relates generally to wireless communication, and more specifically to systems, devices, methods, and techniques associated with techniques for handling uplink transmission in a time period associated with downlink communication in accordance with a periodic switching pattern.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication, determining a resource scheduled for uplink transmission at least partially overlaps in time with an instance of the second time period associated with communications via the second band, and determining whether to perform an uplink transmission in the resource based on a transmission type of the uplink transmission or a resource type of the resource.

A UE for wireless communications is described. The UE may include a processing system that includes processor circuitry and memory circuitry that stores code. The processing system may be configured to cause the UE to receive a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication, determine a resource scheduled for uplink transmission at least partially overlaps in time with an instance of the second time period associated with communications via the second band, and determine whether to perform an uplink transmission in the resource based on a transmission type of the uplink transmission or a resource type of the resource.

Another UE for wireless communications is described. The UE may include means for receiving a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication, means for determining a resource scheduled for uplink transmission at least partially overlaps in time with an instance of the second time period associated with communications via the second band, and means for determining whether to perform an uplink transmission in the resource based on a transmission type of the uplink transmission or a resource type of the resource.

A non-transitory computer-readable medium storing code for wireless communications is described. The code may include instructions executable by one or more processors to receive a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication, determine a resource scheduled for uplink transmission at least partially overlaps in time with an instance of the second time period associated with communications via the second band, and determine whether to perform an uplink transmission in the resource based on a transmission type of the uplink transmission or a resource type of the resource.

Some examples of the method, UEs, and non-transitory computer-readable medium described herein may further include operations, features, means, or instructions for receiving a control message that indicates whether to perform any uplink transmission of a first uplink transmission type that at least partially overlaps in time with any instance of the second time period, where determining whether to perform the uplink transmission may be in accordance with the control message.

In some examples of the method, UEs, and non-transitory computer-readable medium described herein, determining whether to perform the uplink transmission may include operations, features, means, or instructions for determining to drop the uplink transmission based on the transmission type of the uplink transmission being a semi-statically configured uplink transmission.

In some examples of the method, UEs, and non-transitory computer-readable medium described herein, determining whether to perform the uplink transmission may include operations, features, means, or instructions for determining to perform the uplink transmission based on the resource type of the resource being a resource type common to multiple UEs including the UE.

In some examples of the method, UEs, and non-transitory computer-readable medium described herein, determining whether to perform the uplink transmission may include operations, features, means, or instructions for determining to drop the uplink transmission based on the transmission type of the uplink transmission being a configured grant (CG) type uplink transmission.

Some examples of the method, UEs, and non-transitory computer-readable medium described herein may further include operations, features, means, or instructions for receiving an uplink grant that schedules the uplink transmission in the resource, where the uplink grant indicates a priority level associated with the uplink transmission, and where the transmission type of the uplink transmission includes the priority level.

Some examples of the method, UEs, and non-transitory computer-readable medium described herein may further include operations, features, means, or instructions for receiving a physical downlink control channel (PDCCH) order that triggers a physical random access channel (PRACH) transmission in the resource, where the resource may be one of a set of PRACH resources, where determining whether to perform the uplink transmission includes determining to perform the PRACH transmission in the resource based on the transmission type of the uplink transmission being the PRACH transmission.

Some examples of the method, UEs, and non-transitory computer-readable medium described herein may further include operations, features, means, or instructions for receiving a PDCCH order that triggers a PRACH transmission in the resource, where the resource may be one of a set of PRACH resources, where determining whether to perform the uplink transmission includes determining to drop the PRACH transmission in the resource based on the transmission type of the uplink transmission being the PRACH transmission and performing the PRACH transmission in a subsequent PRACH resource of the set of PRACH resources, where the subsequent PRACH resource may be within a subsequent instance of the first time period.

In some examples of the method, UEs, and non-transitory computer-readable medium described herein, determining whether to perform the uplink transmission in the resource may include operations, features, means, or instructions for determining, based on the uplink transmission being a repetition of a set of multiple repetitions of an uplink shared channel transmission or an uplink control channel, to postpone performance of the uplink transmission until an available resource in a subsequent instance of the first time period.

A method for wireless communications by a network entity is described. The method may include outputting, for a UE, a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication, determining a resource scheduled for uplink transmission for the UE that at least partially overlaps in time with an instance of the second time period associated with communication via the second band, and determining whether to monitor for an uplink transmission in the resource based on a transmission type of the uplink transmission or a resource type of the resource.

A network entity for wireless communications is described. The network entity may include a processing system that includes processor circuitry and memory circuitry that stores code. The processing system may be configured to cause the network entity to output, for a UE, a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication, determine a resource scheduled for uplink transmission for the UE that at least partially overlaps in time with an instance of the second time period associated with communication via the second band, and determine whether to monitor for an uplink transmission in the resource based on a transmission type of the uplink transmission or a resource type of the resource.

Another network entity for wireless communications is described. The network entity may include means for outputting, for a UE, a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication, means for determining a resource scheduled for uplink transmission for the UE that at least partially overlaps in time with an instance of the second time period associated with communication via the second band, and means for determining whether to monitor for an uplink transmission in the resource based on a transmission type of the uplink transmission or a resource type of the resource.

A non-transitory computer-readable medium storing code for wireless communications is described. The code may include instructions executable by one or more processors to output, for a UE, a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication, determine a resource scheduled for uplink transmission for the UE that at least partially overlaps in time with an instance of the second time period associated with communication via the second band, and determine whether to monitor for an uplink transmission in the resource based on a transmission type of the uplink transmission or a resource type of the resource.

Some examples of the method, network entities, and non-transitory computer-readable medium described herein may further include operations, features, means, or instructions for outputting, for the UE, a control message that indicates whether to perform any uplink transmission of a first uplink transmission type that at least partially overlaps in time with any instance of the second time period, where determining whether to monitor for the uplink transmission may be in accordance with the control message.

In some examples of the method, network entities, and non-transitory computer-readable medium described herein, determining whether to monitor for the uplink transmission may include operations, features, means, or instructions for determining to drop the uplink transmission based on the transmission type of the uplink transmission being a semi-statically configured uplink transmission.

In some examples of the method, network entities, and non-transitory computer-readable medium described herein, determining whether to monitor for the uplink transmission may include operations, features, means, or instructions for determining to monitor for the uplink transmission based on the resource type of the resource being a resource type common to multiple UEs including the UE.

In some examples of the method, network entities, and non-transitory computer-readable medium described herein, determining whether to monitor for the uplink transmission may include operations, features, means, or instructions for determining to drop the uplink transmission based on the transmission type of the uplink transmission being a CG type uplink transmission.

Some examples of the method, network entities, and non-transitory computer-readable medium described herein may further include operations, features, means, or instructions for outputting an uplink grant that schedules the uplink transmission in the resource, where the uplink grant indicates a priority level associated with the uplink transmission, and where the transmission type of the uplink transmission includes the priority level.

Some examples of the method, network entities, and non-transitory computer-readable medium described herein may further include operations, features, means, or instructions for outputting a PDCCH order that triggers a PRACH transmission in the resource, where the resource may be one of a set of PRACH resources, where determining whether to monitor for the uplink transmission includes determining to monitor for the PRACH transmission in the resource based on the transmission type of the uplink transmission being the PRACH transmission.

Some examples of the method, network entities, and non-transitory computer-readable medium described herein may further include operations, features, means, or instructions for outputting a PDCCH order that triggers a PRACH transmission in the resource, where the resource may be one of a set of PRACH resources, where determining whether to monitor for the uplink transmission includes determining to drop the PRACH transmission in the resource based on the transmission type of the uplink transmission being the PRACH transmission and monitoring for the PRACH transmission in a subsequent PRACH resource of the set of PRACH resources, where the subsequent PRACH resource may be within a subsequent instance of the first time period.

In some examples of the method, network entities, and non-transitory computer-readable medium described herein, determining whether to monitor for the uplink transmission may include operations, features, means, or instructions for determining, based on the uplink transmission being a repetition of a set of multiple repetitions of an uplink shared channel transmission or an uplink control channel, to postpone monitoring for the uplink transmission until an available resource in a subsequent instance of the first time period.

Some examples of the method, network entities, and non-transitory computer-readable medium described herein may further include operations, features, means, or instructions for the periodic switching pattern including carrier aggregation switching between a first carrier component in the first band configured for frequency division duplexing (FDD) and a second carrier component in the second band configured for supplementary downlink (SDL), where the switching occurs at a carrier component level.

### BRIEF DESCRIPTION OF THE DRAWINGS

FIG. 1 shows an example of a wireless communication system.

FIG. 2 shows an example of a band switching diagram that supports techniques for handling uplink transmission in a time period associated with downlink communication in accordance with a periodic switching pattern.

FIG. 3 shows an example of a signaling diagram that supports techniques for handling uplink transmission in a time period associated with downlink communication in accordance with a periodic switching pattern.

FIG. 4 shows examples of timing diagrams that support techniques for handling uplink transmission in a time period associated with downlink communication in accordance with a periodic switching pattern.

FIG. 5 shows an example of a timing diagram that supports techniques for handling uplink transmission in a time period associated with downlink communication in accordance with a periodic switching pattern.

FIG. 6 shows an example of a process flow that supports techniques for handling uplink transmission in a time period associated with downlink communication in accordance with a periodic switching pattern.

FIG. 7 shows a block diagram of a processing system that supports techniques for handling uplink transmission in a time period associated with downlink communication in accordance with a periodic switching pattern.

FIG. 8 shows a diagram of a system including a device that supports techniques for handling uplink transmission in a time period associated with downlink communication in accordance with a periodic switching pattern.

FIG. 9 shows a block diagram of a processing system that supports techniques for handling uplink transmission in a time period associated with downlink communication in accordance with a periodic switching pattern.

FIG. 10 shows a diagram of a system including a device that supports techniques for handling uplink transmission in a time period associated with downlink communication in accordance with a periodic switching pattern.

FIGS. 11 and 12 show flowcharts illustrating methods that support techniques for handling uplink transmission in a time period associated with downlink communication in accordance with a periodic switching pattern.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other targets, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may be configured with a switching pattern between frequency bands to enable low band carrier aggregation. For example, the UE may be configured with a first band that is used for both uplink communication and downlink communication and a second band that is used for downlink communication. The UE may be configured with a pattern for switching between operation on the first band and the second band. In some examples, the first band may be a frequency division duplexing (FDD) band and may include a downlink subband for downlink communication and an uplink subband for uplink communication. In some examples, the second band may be a supplementary downlink (SDL) band. For example, a radio resource control (RRC) configuration may indicate a semi-static or periodic switching pattern for the UE between instances of a period in which the UE operates in the first band (which may be referred to as a T1 period) and instances of a period in which the UE operates in the second band (which may be referred to as a T2 period). As the UE may not be able to transmit in the second band (e.g., an SDL band), UE behavior for uplink transmissions scheduled during an instance of the T2 period may be undefined.

Aspects of the subject matter described in this disclosure relate to methods, rules, and/or processes for determining whether to perform an uplink transmission in a resource scheduled at least partially within an instance of the T2 period (e.g., scheduled in an instance of a period associated with downlink communication only in accordance with a configured switching pattern). For example, the UE may determine whether to perform an uplink transmission in a resource scheduled for uplink transmission that is within (e.g., at least partially overlaps in time with) an instance of the T2 period based on the transmission type of the uplink transmission or the resource type of the resource in which the uplink transmission is scheduled. The network entity may similarly determine whether to monitor for an uplink transmission in a resource scheduled for uplink transmission that is within (e.g., at least partially overlaps in time with) an instance of the T2 period based on the transmission type of the uplink transmission or the resource type of the resource in which the uplink transmission is scheduled. For example, if the UE drops an uplink transmission in a given instance of the T2 period, the UE may switch to operation on the SDL band for the given instance of the T2 period. As another example, if the UE determines to perform an uplink transmission in a given instance of the T2 period, the UE may remain in operation in the FDD band to perform the uplink transmission during the instance of the T2 period (e.g., the UE may not switch to the SDL band for the given instance of the T2 period in order to perform the uplink transmission).

In some cases, the UE may determine to perform uplink transmissions in common-type resources such as common physical uplink control channel (PUCCH) resources or common random access channel (RACH) resources. In some cases, the UE may determine to drop uplink transmissions based on a rule (which can be defined in the standards) that indicates to drop or perform given types of uplink transmissions, such as semi-statically scheduled uplink transmissions (such as semi-persistent scheduled sounding reference signals (SRSs), PUCCH transmissions, or configured grant (CG) physical uplink shared channel (CG-PUSCH) transmissions) or dynamically scheduled uplink transmissions (PUSCH scheduled by a downlink control information (DCI) message, a first CG-PUSCH of a type2 CG, a PUCCH for hybrid automatic repeat request (HARQ) acknowledgment (ACK) feedback). In some examples, the network entity may indicate via control signaling which types of uplink transmissions to perform within instances of the T2 period and which types of uplink transmissions to drop within instances of the T2 period. For example, for semi-statically scheduled transmissions, the control signaling that schedules the semi-statically scheduled transmissions may indicate whether to skip or perform such transmissions that occur in instances of the T2 period.

Particular aspects of the subject matter described in this disclosure can be implemented to realize one or more of the following potential advantages. In some examples, by the UE determining whether to perform, and the network entity 105 determining whether to monitor for, an uplink transmission in a resource scheduled for uplink transmission that is within an instance of a T2 period based on the transmission type of the uplink transmission or the resource type of the resource in which the uplink transmission is scheduled, the described techniques can be used to ensure that the UE and the network entity perform corresponding behaviors for uplink transmissions in resources scheduled for uplink transmission that are within instances of T2 periods. Accordingly, uplink transmissions expected by the network entity within an instance of a T2 time period may not be dropped by the UE, the network entity may not miss monitoring for uplink transmissions performed by the UE, and/or the network entity and the UE may save energy by not monitoring for and not performing uplink transmissions that are determined to be dropped.

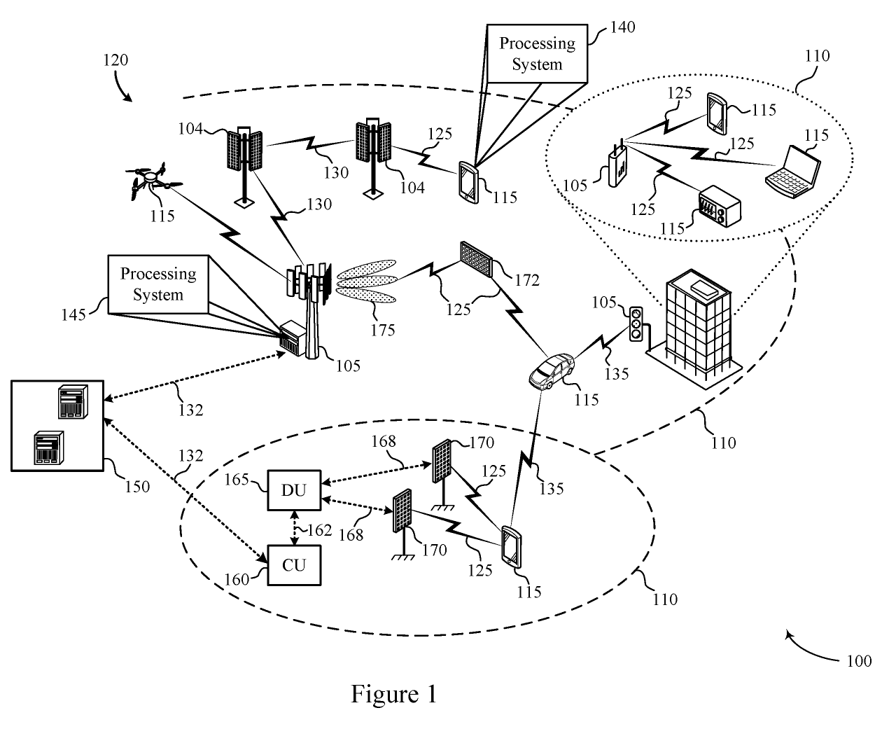

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, an RRC layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a PUSCH for communicating user data in an uplink direction. Physical control channels (such as for managing communication via physical channels) may include a physical downlink control channel (PDCCH) for communicating DCI and a PUCCH for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, SRSs that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for techniques for handling uplink transmission in a time period associated with downlink communication in accordance with a periodic switching pattern. For example, a UE 115 may include a processing system 140, and a network entity 105 may include a processing system 145, each of which may be configured to cause the respective device to perform (such as being configured as means for performing) one or more of the described operations. As described herein, the network entity 105 may configure a UE 115 with a switching pattern between frequency bands to enable low band carrier aggregation. For example, the UE 115 may be configured with a first band that is used for both uplink communication and downlink communication and a second band that is used for downlink communication. The UE 115 may be configured with a pattern for switching between operation on the first band and the second band. For example, an RRC configuration may indicate a semi-static or periodic switching pattern for the UE 115 between instances of periods in which the UE operates in the first band (which may be referred to as T1 periods) and instances of periods in which the UE 115 operates in the second band (which may be referred to as T2 periods). By configuring a processing system 140, a processing system 145, or a combination thereof in accordance with the described techniques, the wireless communication system 100 (such as the RAN 120) may support determination by the UE 115 of whether to perform, and determination by the network entity 105 of whether to monitor for, an uplink transmission in a resource scheduled for uplink transmission that is within an instance of the second period based on the transmission type of the uplink transmission or the resource type of the resource in which the uplink transmission is scheduled.

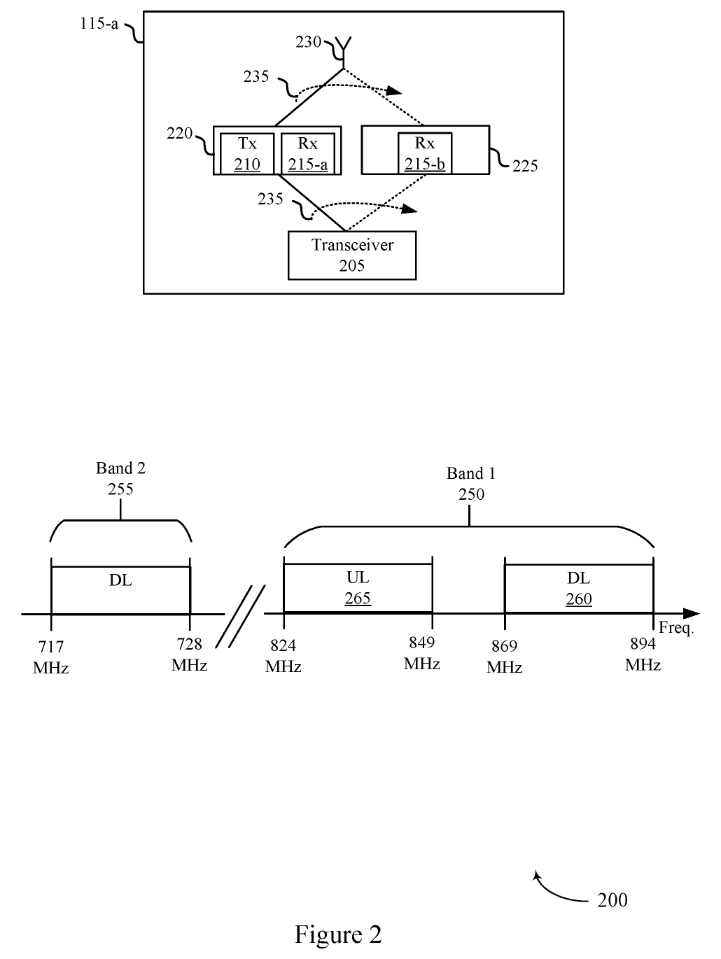

FIG. 2 shows an example of a band switching diagram 200 that supports techniques for handling uplink transmission in a time period associated with downlink communication in accordance with a periodic switching pattern. The band switching diagram 200 may implement or may be implemented by aspects of the wireless communication system 100. For example, the band switching diagram 200 may illustrate a UE 115-a which may switch between two bands configured for the UE 115-a, where the UE 115-a may be a UE 115 as described herein.

As described herein, a UE 115-a may implement low band – low band carrier aggregation. For example, the UE 115-a may include a transceiver 205 capable of switching (e.g., via one or more switches 235) between first transceiver circuitry 220 and the second transceiver circuitry 225, where the first transceiver circuitry 220 includes transmitter circuitry 210 and receiver circuitry 215-a, and the second transceiver circuitry 225 includes receiver circuitry 215-b. The UE 115-a may transmit/receive signals using one or more antennas 230, which may be switched between the first transceiver circuitry 220 and the second transceiver circuitry 225 (e.g., via one or more switches 235). For example, the fractional bandwidth of a single antenna 230 to support a carrier aggregation between the first band 250 and the second band 255 may be 22%. In some examples, the UE 115-a may demand a switching gap (e.g., in time) between operation on a first band 250 associated with both uplink and downlink communication (e.g., which may involve use of the first transceiver circuitry 220) and a second band 255 associated with downlink-only communication (e.g., which may involve use of the second transceiver circuitry 225).

For example, “case 1” or “time period 1” may refer to a state or time period in which the UE 115-a may transmit and receive on the first band 250 (e.g., an FDD band or carrier) using the first transceiver circuitry 220 and may not receive on the second band 255. “Case 2” or “time period 2” may refer to a state or time period in which the UE 115-a may receive on the second band 255 (e.g., which may be an SDL band or carrier). In some examples, the UE 115-a may be configured (e.g., via an RRC configuration) with a semi-static switching pattern between case 1 and case 2. In some examples, the UE 115-a may be configured (e.g., via the RRC configuration) with a switching delay and/or time mask for switching between case 1 and case 2. In some examples, the carrier frequencies for the first band 250 and the second band 255 may be below 1 GHz. For example, as shown, the first band 250 may include an uplink subband 265 between 824 MHz and 849 MHz and a downlink subband 260 between 869 MHz and 894 MHz. The second band 255 may be between 717 MHz and 728 MHz. In some examples, the uplink subband 265 may be an n5 uplink band, the downlink subband 260 may be an n5 downlink band, and the second band 255 may be an n29 downlink band. For example, the UE 115-a may implement low band—low band carrier aggregation using CA_n5A-n29A carrier aggregation as described in the 3rd Generation Partnership Project (3GPP) TS 38.101-1.

This carrier aggregation may involve switching between a first carrier component in the n5 band (FDD) and a second carrier component in the n29 band (SDL), where the switching may occur at the carrier component level rather than at the symbol or slot level within a single carrier. The switching between the first band 250 and the second band 255 may involve carrier-level switching in a carrier aggregation context, where the UE may switch between different carrier components rather than performing frequency-domain separation within individual symbols or slots. This may be distinct from SBFD scenarios or other scenarios where a single carrier may be divided in the frequency domain within individual symbols to enable simultaneous uplink and downlink operations. The periodic switching pattern may operate at a longer time scale than symbol-level operations and may involve physical switching between the first transceiver circuitry 220 and the second transceiver circuitry 225.

In some examples, the network deployment may be co-located and synchronized for both carriers (e.g., the same network entity 105 may communicate with the UE 115 via both the first band 250 and the second band 255). In some examples, both carriers (e.g., the first band 250 and the second band 255) may be included within the same timing advance group (TAG). In some examples, both carriers (e.g., the first band 250 and the second band 255) may use a 15 kHz subcarrier spacing (SCS). In contrast to SBFD operations that involve frequency-domain separation within individual symbols or slots, the described techniques involve switching between different carrier components in a carrier aggregation configuration (e.g., between a first carrier in a first band (FDD band) and a second carrier in a second band (SDL band)).

As used herein, “dropping” an uplink transmission refers to any action by a network entity or UE to not process, utilize, or act upon an uplink transmission that would otherwise be expected to be processed or acted upon. For a network entity, dropping may include: (1) refraining from monitoring for an uplink transmission in a scheduled resource, (2) receiving an uplink transmission but refraining from processing, decoding, or otherwise acting upon the received transmission, (3) ignoring or discarding a received uplink transmission, or (4) any combination thereof. For a UE, dropping may include refraining from transmitting an uplink transmission in a scheduled resource. The determination to drop may be made before, during, or after the time period associated with the scheduled resource.

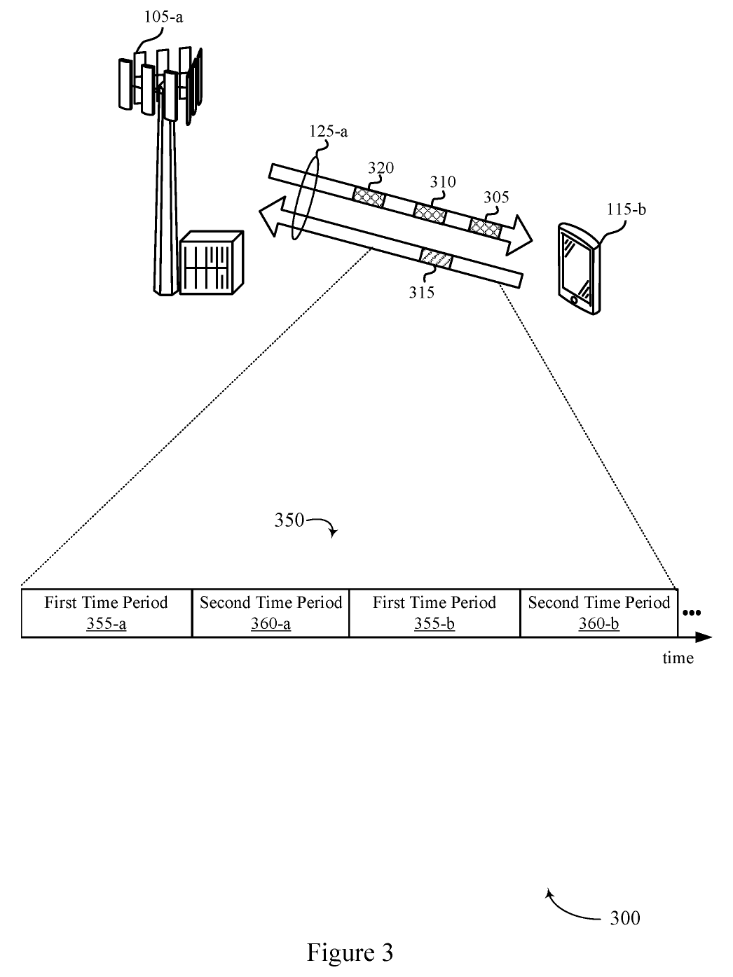

FIG. 3 shows an example of a signaling diagram 300 that supports techniques for handling uplink transmission in a time period associated with downlink communication in accordance with a periodic switching pattern. The signaling diagram 300 may implement or may be implemented by aspects of the wireless communication system 100 or the band switching diagram 200. For example, the signaling diagram 300 may include a UE 115-b which may be an example of a UE 115 as described herein. The signaling diagram 300 may include a network entity 105-a, which may be an example of a network entity 105 as described herein.

The UE 115-b may communicate with the network entity 105-a using a communication link 125-a, which may be an example of a communication link 125 as described herein. For example, the communication link 125-a may be an example of an NR or LTE link between the UE 115-b and the network entity 105-a. The communication link 125-a may include a bi-directional link that enables both uplink and downlink communications. For example, the UE 115-b may transmit uplink signals (e.g., uplink transmissions), such as uplink control signals or uplink data signals, to the network entity 105-a using the communication link 125-a and the network entity 105-a may transmit downlink signals (e.g., downlink transmissions), such as downlink control signals or downlink data signals, to the UE 115-b using the communication link 125-a.

As described herein, the UE 115-b may receive, from the network entity 105-a, a configuration 310 (e.g., via RRC signaling) of a periodic switching pattern for communications via a first band and a second band. The periodic switching pattern may associate communications via the first band with instances of a first time period 355 and communications via the second band with instances of a second time period 360 that are interspersed with the instances of the first time period 355, where the first band is associated with both uplink communication and downlink communication, and where the second band is associated with downlink communication. For example, the first time period may be an example of a T1 period or case 1 as described herein, and the second time period may be an example of a T2 period or case 2 as described herein. As shown in the timing diagram 350, the periodic switching pattern may include a first instance of the first time period 355-a, a first instance of the second time period 360-a, a second instance of the first time period 355-b, and a second instance of the second time period 360-b. The periodic switching pattern described herein involves switching between carrier components in a carrier aggregation configuration rather than symbol-level or slot-level frequency differentiation within a single carrier. The first band may correspond to a primary cell (PCell) operating as an FDD carrier, while the second band may correspond to a SDL secondary cell (SCell). The switching may occur between these different carrier components at the carrier aggregation level, not within individual transmission symbols.

During the instances of the first time period 355, the UE 115-b may both transmit uplink signals and receive downlink signals via the first band. During instances of the second time period 360, the UE 115-b may receive downlink signals via the second band. The configuration 310 may indicate a switching delay and mask time for switching between operation on the first band and the second band. As described herein, in case 2 (e.g., when operating on the second band using transceiver circuitry associated with the second band), the UE 115-b may not be able to perform an uplink transmission 315 using the first band. For example, the uplink transmission 315 may be a semi-statically configured uplink transmission in an instance of the second time period 360, a dynamically scheduled uplink transmission in an instance of the second time period 360, or a physical random access channel (PRACH) transmission in an instance of the second time period 360. In some examples, as described herein, the UE 115-b may determine whether to perform, and the network entity 105-a may determine whether to monitor for, the uplink transmission 315 in a resource scheduled for uplink transmission that is within an instance of the second time period 360 based on the transmission type of the uplink transmission 315 or the resource type of the resource in which the uplink transmission 315 is scheduled. As used herein, “interspersed” may mean distributed among or positioned between in time, including regular or irregular alternating patterns, overlapping arrangements, or any temporal distribution where instances of the second time period occur between, among, or in alternation with instances of the first time period.

In some examples, the UE 115-b and the network entity 105-a may drop a semi-static uplink transmission within an instance of the second time period 360. For example, the UE 115-b may drop, and the network entity 105-a may not monitor for, the uplink transmission 315 if the uplink transmission 315 is semi-statically configured and is scheduled within instance of the second time period 360. In some examples, a rule (e.g., a standardized rule) may mandate that all semi-statically configured uplink transmissions may be dropped when scheduled within (e.g., partially overlapping with) instances of the second time period 360 associated with operation on the second band of the switching pattern. For example, semi-statically configured uplink transmissions may include periodic or semi-persistent SRS, PUCCH transmissions, or CG-PUSCH transmissions). Semi-statically configured uplink transmissions may be configured or scheduled via control signaling 305 (e.g., via an RRC configuration).

In some examples, the network entity 105-a may configure (e.g., via control signaling 305) whether semi-statically configured uplink transmissions or specific types of semi-statically configured uplink transmissions are to be dropped when scheduled within instances of the second time period 360 associated with operation on the second band of the switching pattern. For example, the SRS-Resource (e.g., a field or information element included in the control signaling 305) set for a semi-statically configured SRS may indicate (e.g., may include a field that indicates) whether to drop such semi-statically configured SRSs that are scheduled within (e.g., partially overlapping with) instances of the second time period 360. As another example, the PUCCH-Config (e.g., a field or information element in the control signaling 305) for PUCCH may indicate (e.g., may include a field that indicates) whether to drop such semi-statically PUCCH transmissions that are scheduled within (e.g., partially overlapping with) instances of the second time period 360. As another example, the ConfiguredGrantConfig (e.g., a field or information element included in the control signaling 305) for CG-PUCCH may indicate (e.g., may include a field that indicates) whether to drop such semi-statically CG-PUSCH transmissions that are scheduled within (e.g., partially overlapping with) instances of the second time period 360.

In some examples, the UE 115-b may not drop, and the network entity 105-a may monitor for, semi-statically configured uplink transmissions scheduled within instances of the second time period 360 associated with operation on the second band of the switching pattern when the semi-statically configured uplink transmissions are scheduled in common uplink resources (e.g., resources configured as available to multiple UEs 115). For example, such common configured resources may include PUCCH resources configured via PUCCH-ConfigCommon and RACH resources configured via rach-ConfigCommon. Not dropping common resources may enable backwards compatibility for UEs that are not configured with low band – low band carrier aggregation with receive band switching.

In some examples, a control message 320 may dynamically schedule the uplink transmission 315 within an instance of the second time period 360 associated with operation on the second band of the switching pattern. In some such examples, a rule (e.g., a standardized rule) may specify whether such a dynamically scheduled uplink transmission is dropped based on the type of dynamically scheduled uplink transmission. For example, a rule may specify that dynamically scheduled PUSCH and SRS within an instance of the second time period 360 may be dropped but that a dynamically scheduled PUCCH within an instance of the second period may not be dropped. As another example, a rule may specify that dynamically scheduled uplink transmissions within an instance of the second time period 360 may be dropped if below a threshold priority level and may be performed if at or above the threshold priority level (e.g., and the control message 320 that dynamically schedules the uplink transmission 315 may indicate the priority level of the uplink transmission 315 which can be compared to the threshold priority level).

In some examples, network entity 105-a may configure (e.g., via control signaling 305) whether dynamically scheduled uplink transmissions or specific types of semi-statically configured uplink transmissions are to be dropped when scheduled within instances of the second time period 360 associated with operation on the second band of the switching pattern. For example, the network entity 105-a may provide separate configurations of whether to drop dynamically scheduled PUSCH transmissions, dynamically scheduled PUCCH transmissions, and dynamically scheduled SRSs scheduled within instances of the second time period 360. In some examples, the network entity 105-a may provide separate configurations of whether to drop different such dynamically scheduled uplink transmissions of different priority levels. Dynamically scheduled uplink transmissions may include: a PUSCH transmission scheduled by an uplink grant, a first CG-PUSCH occasion of a type2 CG, PUCCH for HARQ ACK feedback for a dynamically scheduled PDSCH transmission, and aperiodic SRS triggered by a DCI message.

In some examples, the control message 320 may be a PDCCH order that triggers a contention free RACH for the UE 115-b. In some such examples, the UE 115-b may transmit a corresponding PRACH via the first RACH occasion after the PDCCH order regardless of whether the first RACH occasion is within an instance of the first time period 355 or an instance of the second time period 360. For example, the uplink transmission 315 may be a contention free PRACH within a first RACH resource after the PDCCH order, where the first RACH resource is within an instance of the second time period 360. For example, if the PDCCH order is received in the first instance of the second time period 360-a, the UE 115-b may perform a PRACH(e.g., perform a random access transmission/preamble transmission) in a RACH resource of the second time period 360-a after receiving the PDCCH order. In some examples, after a PDCCH order that triggers a contention free RACH for the UE 115-b, the UE 115-b may transmit a corresponding PRACH via the first RACH occasion within an instance of the first time period 355 after the PDCCH order. The network entity 105-a may ensure that such a RACH occasion is available in the subsequent instance of the first time period 355. For example, if the PDCCH order is received in the first instance of the second time period 360-a, the UE 115-b may transmit the PRACH in a RACH resource of the second instance of the first time period 355-b even if a RACH resource is scheduled within the first instance of the second time period 360-a after the PDCCH order. It should be understood that the signaling diagram 300 illustrates one example sequence of communications and signaling. The control signaling 305, configuration 310, and control message 320 may occur in any temporal order, may be repeated multiple times, may be combined into fewer communications, may be divided into additional signaling events, or may include other signaling not explicitly shown. The specific ordering shown is for illustrative purposes only and is not intended to limit the scope of the described techniques

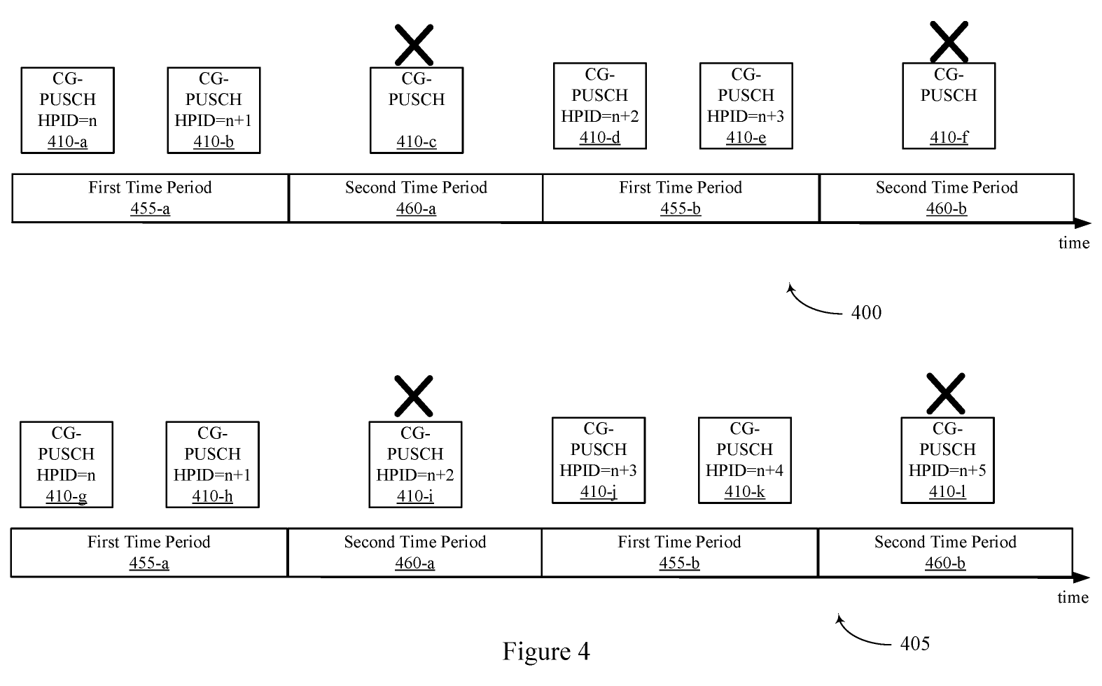

FIG. 4 shows an example of a timing diagram 400 and a timing diagram 405 that support techniques for handling uplink transmission in a time period associated with downlink communication in accordance with a periodic switching pattern. The timing diagram 400 and the timing diagram 405 may implement or may be implemented by aspects of the wireless communication system 100, the band switching diagram 200, or the signaling diagram 300. For example, the timing diagram 400 and the timing diagram 405 may illustrate scheduling of CG-PUSCH transmissions within a band switching pattern.

As described herein, a UE 115 may be configured with a periodic switching pattern for communications via a first band and a second band. The periodic switching pattern may associate communications via the first band with instances of a first time period 455 and communications via the second band with instances of a second time period 460 that are interspersed with the instances of the first time period 455, where the first band is associated with both uplink communication and downlink communication, and where the second band is associated with downlink communication. For example, as shown in the timing diagram 400 and the timing diagram 405, the periodic switching pattern may include a first instance of the first time period 455-a, a first instance of the second time period 460-a, a second instance of the first time period 455-b, and a second instance of the second time period 460-b. In some examples, as described herein, the UE 115 may be configured to drop CG-PUSCHs in CG-PUSCH occasions 410 scheduled within instances of the second time period 460.

In some such examples, as shown in the timing diagram 400, a CG-PUSCH occasion 410 within an instance of the second time period 460 may be considered by the UE 115 and the network entity 105 as invalid. For example, the handling of a CG-PUSCH occasion 410 within an instance of the second time period 460 may follow the same procedure as the handling of a CG-PUSCH occasion that collides with a synchronization signal block (SSB). For example, the HARQ process identifier (HPID) for such CG-PUSCHs may not be incremented for CG-PUSCH occasions 410 within an instance of the second time period 460. As shown in the timing diagram 400, for example, the UE 115 may perform a CG-PUSCH transmission in the CG-PUSCH occasion 410-a (where HPID=n), the UE 115 may perform a CG-PUSCH transmission in the CG-PUSCH occasion 410-b (where HPID=n+1), the UE 115 may perform a CG-PUSCH transmission in the CG-PUSCH occasion 410-d (where HPID=n+2), and the UE 115 may perform a CG-PUSCH transmission in the CG-PUSCH occasion 410-e (where HPID=n+3), as each of the CG-PUSCH occasion 410-a, the CG-PUSCH occasion 410-b, the CG-PUSCH occasion 410-d, and the CG-PUSCH occasion 410-e are within instances of the first time period 455. The UE 115 may not perform (e.g., may drop) a CG-PUSCH occasion in the CG-PUSCH occasion 410-c and the CG-PUSCH occasion 410-f, as the CG-PUSCH occasion 410-c and the CG-PUSCH occasion 410-f are within instances of the second time period 460. The UE 115 may consider the CG-PUSCH occasion 410-c and the CG-PUSCH occasion 410-f as invalid and accordingly may not increment the HPID for the CG-PUSCH occasion 410-c and the CG-PUSCH occasion 410-f.

In some such examples, as shown in the timing diagram 405, a CG-PUSCH occasion 410 within an instance of the second time period 460 may be considered by the UE 115 and the network entity 105 as valid but dropped. For example, the handling of a CG-PUSCH occasion 410 within an instance of the second time period 460 may follow the procedure for handling of a CG-PUSCH which is dropped due to a collision with a dynamically scheduled downlink transmission. For example, the HPID for such CG-PUSCHs that are dropped may be incremented for CG-PUSCH occasions 410 within an instance of the second time period 460. As shown in the timing diagram 405, for example, the UE 115 may perform a CG-PUSCH transmission in the CG-PUSCH occasion 410-g (where HPID=n), the UE 115 may perform a CG-PUSCH transmission in the CG-PUSCH occasion 410-h (where HPID=n+1), the UE 115 may drop a CG-PUSCH occasion in the CG-PUSCH occasion 410-i but may increment the HPID to n+2, the UE 115 may perform a CG-PUSCH transmission in the CG-PUSCH occasion 410-j (where HPID=n+3), the UE 115 may perform a CG-PUSCH transmission in the CG-PUSCH occasion 410-k (where HPID=n+4), and the UE 115 may drop a CG-PUSCH occasion in the CG-PUSCH occasion 410-l but may increment the HPID to n+5. The CG-PUSCH occasions 410 may be scheduled across the carrier aggregation switching pattern between the FDD carrier (first band) and SDL carrier (second band). The dropping of CG-PUSCH occasions within instances of the second time period 460 may be based on the carrier-level switching between different carrier components, not on symbol-level frequency domain separation as may occur in SBFD operations. Each CG-PUSCH occasion 410 may represent a transmission opportunity on the FDD carrier component during the carrier aggregation switching cycle.

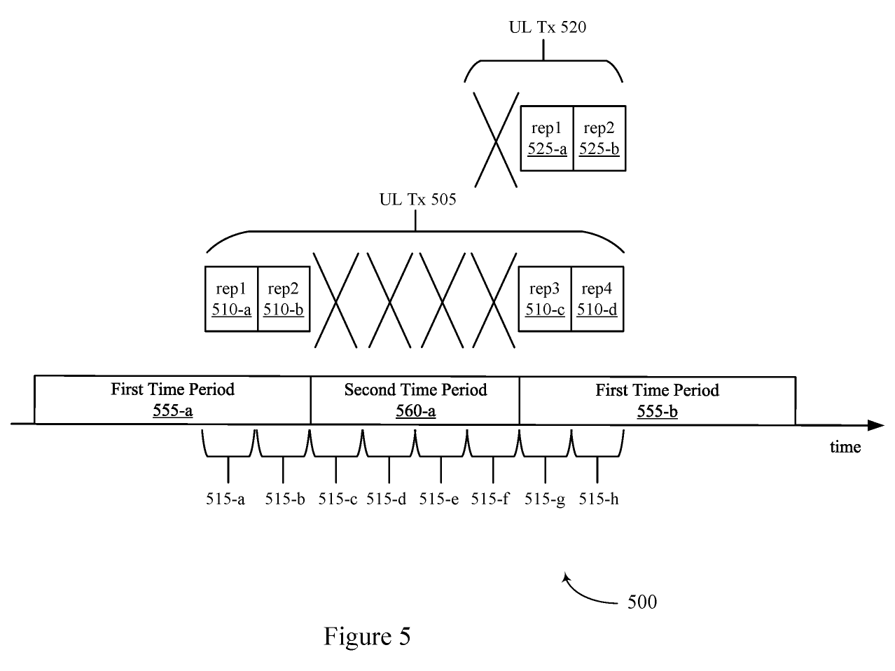

FIG. 5 shows an example of a timing diagram 500 that supports techniques for handling uplink transmission in a time period associated with downlink communication in accordance with a periodic switching pattern. The timing diagram 500 may implement or may be implemented by aspects of the wireless communication system 100, the band switching diagram 200, or the signaling diagram 300. For example, the timing diagram 500 may illustrate repetitions of an uplink transmission scheduled across periods of a band switching pattern.

As described herein, a UE 115 may be configured with a periodic switching pattern for communications via a first band and a second band. The periodic switching pattern may associate communications via the first band with instances of a first time period 555 and communications via the second band with instances of a second time period 560 that are interspersed with the instances of the first time period 555, where the first band is associated with both uplink communication and downlink communication, and where the second band is associated with downlink communication. For example, as shown in the timing diagram 500, the periodic switching pattern may include a first instance of the first time period 555-a, a first instance of the second time period 560-a, and a second instance of the first time period 555-b.

Some uplink transmissions, such as PUSCH and/or PUCCH transmissions, may be scheduled with multiple repetitions of the PUSCH or PUCCH transmission. For example, a PUSCH or PUCCH transmission may include a transport block which is transmitted multiple times in multiple time resources to increase the probability the network entity 105 is able to successfully decode the transport block. In some examples, when a repetition 510 of a PUSCH or PUCCH transmission collides (e.g., at least partially overlaps with) an instance of the second time period 560, the repetition may be postponed until a next available or valid time resource (e.g., a next available time resource in a subsequent instance of the first time period 555).

For example, a PUSCH or PUCCH transmission 505 with four repetitions 510 may be scheduled to begin with a first repetition 510-a in a time resource 515-a within the first instance of the first time period 555-a. The second repetition 510-b of the PUSCH or PUCCH transmission 505 may be performed in a time resource 515-b within the first instance of the first time period 555-a. Four time resources 515 (the time resource 515-c, the time resource 515-d, the time resource 515-e, and the time resource 515-f) may be within the first instance of the second time period 560-a, and thus the UE may postpone performance of the third repetition 510-c and the fourth repetition 510-d, until the time resource 515-g and the time resource 515-h within second instance of the first time period 555-b, respectively.

As another example, a PUSCH or PUCCH transmission 520 with two repetitions 525 may be scheduled to begin in the time resource 515-f. The UE 115 may postpone the first repetition 525-a until the time resource 515-g within the second instance of the first time period 555-b, and the UE 115 may perform the second repetition 525-b in the time resource 515-h within the second instance of the first time period 555-b. The repetitions 510 and 525 of PUSCH or PUCCH transmissions may be postponed based on the carrier aggregation switching pattern between the FDD carrier and SDL carrier. This postponement mechanism may be distinct from symbol-level collision handling in systems that operate based on symbol or slot level switching patterns, as the postponement techniques may operate at the carrier component level within the carrier aggregation framework. The postponement may ensure that uplink transmissions occur during periods when the UE may be operating on the FDD carrier component that supports uplink communication

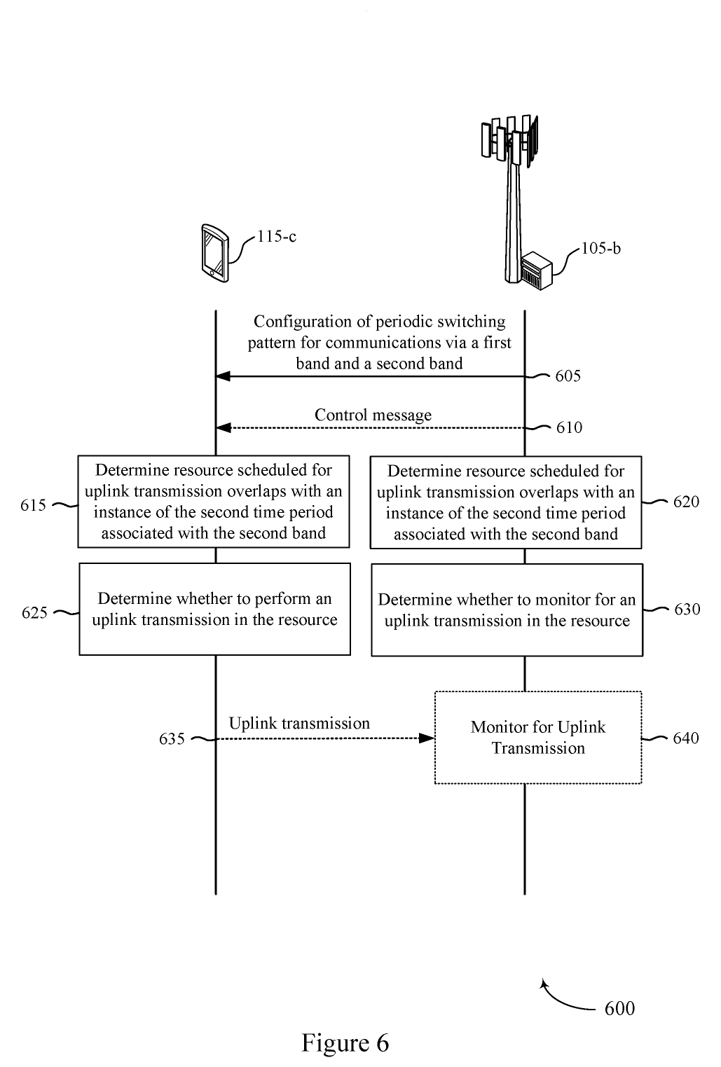

FIG. 6 shows an example of a process flow 600 that supports techniques for handling uplink transmission in a time period associated with downlink communication in accordance with a periodic switching pattern. The process flow 600 may implement or may be implemented by aspects of the wireless communication system 100, the band switching diagram 200, the signaling diagram 300, the timing diagram 400, the timing diagram 405, or the timing diagram 500. For example, the process flow 600 may include a UE 115-c, which may be an example of a UE 115 as described herein. The process flow 600 may also include a network entity 105-b, which may be an example of a network entity 105 as described herein. In the following description of the process flow 600, the communications between the network entity 105-b and the UE 115-c may be transmitted in a different order than the example order shown, or the operations performed by the network entity 105-b and the UE 115-c may be performed in different orders or at different times. Some operations may also be omitted from the process flow 600, and other operations may be added to the process flow 600.

At 605, the UE 115-c may receive, from the network entity 105-b, a configuration of a periodic switching pattern for communications via a first band and a second band. The periodic switching pattern may associate communications via the first band with instances of a first time period and communications via the second band with instances of a second time period that are interspersed with the instances of the first time period. The first band may be associated with both uplink communication and downlink communication (e.g., may support or be configured for both uplink and downlink communication), and the second band may be associated with downlink communication (e.g., may support or be configured for only downlink communication). The configuration of the periodic switching pattern at 605 may establish a carrier aggregation framework where the first band may operate as a PCell with FDD capability and the second band may operate as a SDL SCell. This carrier-level switching configuration may be distinct from other configurations where frequency-domain separation may occur within individual symbols or slots on a single carrier.

At 615, the UE 115-c may determine that a resource scheduled for uplink transmission at least partially overlaps in time with an instance of the second time period associated with communications via the second band. At 620, the network entity 105-b may similarly determine that the resource scheduled for uplink transmission at least partially overlaps in time with the instance of the second time period associated with communications via the second band.

At 625, the UE 115-c may determine whether to perform an uplink transmission in the resource based on a transmission type of the uplink transmission or a resource type of the resource. Similarly, at 630, the network entity 105-b may determine whether to monitor for the uplink transmission in the resource based on the transmission type of the uplink transmission or the resource type of the resource.

In some examples, at 610, the UE 115-c may receive, from the network entity 105-b, a control message that indicates whether to perform any uplink transmission of a first uplink transmission type that at least partially overlaps in time with any instance of the second time period, and determining whether to perform the uplink transmission at 625 and 630 may be in accordance with the control message. For example, the control message at 610 may correspond to the control signaling 305 as described with reference to FIG. 3. In some examples, the control message may include scheduling information for a set of semi-statically configured resources associated with uplink transmissions of the first uplink transmission type. In some examples, the control message may include an uplink grant that schedules the uplink transmission in the resource, and the uplink grant may indicate that the transmission type of the uplink transmission is the first uplink transmission type.

In some examples, at 625, the UE 115-c may determine to drop the uplink transmission based on the transmission type of the uplink transmission being a semi-statically configured uplink transmission. Similarly, at 630, the network entity 105-b may determine to drop the uplink transmission based on the transmission type of the uplink transmission being the semi-statically configured uplink transmission.

In some examples, at 625, the UE 115-c may determine to perform the uplink transmission based on the resource type of the resource being a resource type common to multiple UEs including the UE 115-c. Similarly, at 630, the network entity 105-b may determine to monitor for the uplink transmission based on the resource type of the resource being the resource type common to multiple UEs including the UE 115-c. In such examples, at 635, the UE 115-c may perform the uplink transmission, and at 640, the network entity 105-b may monitor for the uplink transmission.

In some examples, at 625, the UE 115-c may determine to drop the uplink transmission based on the transmission type of the uplink transmission being a CG type uplink transmission. Similarly, at 630, the network entity 105-b may determine to drop the uplink transmission based on the transmission type of the uplink transmission being the CG type uplink transmission. In some such examples, the UE 115-c and the network entity 105-b may increment an HPID counter associated with the dropped CG type uplink transmission (e.g., where such CG occasions are considered valid but dropped). In some such examples, the UE 115-c and the network entity 105-b may skip incrementing an HPID counter associated with the dropped CG type uplink transmission (e.g., where such CG occasions are considered invalid).

In some examples, the UE 115-c may receive, from the network entity 105-b, an uplink grant that schedules the uplink transmission in the resource. In some such examples, the uplink grant may indicate a priority level associated with the uplink transmission, and the transmission type of the uplink transmission may include the priority level.

In some examples, the UE 115-c may receive, from the network entity 105-b, a PDCCH order that triggers a PRACH transmission in the resource, where the resource is one of a set of PRACH resources. In such examples, determining whether to perform the uplink transmission at 625 may include determining to perform the PRACH transmission in the resource based on the transmission type of the uplink transmission being the PRACH transmission. Similarly, determining whether to monitor for the uplink transmission at 630 may include determining to monitor for the PRACH transmission in the resource based on the transmission type of the uplink transmission being the PRACH transmission.

In some examples, the UE 115-c may receive, from the network entity 105-b, a PDCCH order that triggers a PRACH transmission in the resource, where the resource is one of a set of PRACH resources. In such examples, determining whether to perform the uplink transmission at 625 may include determining to drop the PRACH transmission in the resource based on the transmission type of the uplink transmission being the PRACH transmission. Similarly, determining whether to monitor for the uplink transmission at 630 may include determining to drop the PRACH transmission in the resource based on the transmission type of the uplink transmission being the PRACH transmission. In such examples, the UE 115-c may perform, and the network entity 105-b may monitor for, the PRACH transmission in a subsequent PRACH resource of the set of PRACH resources, where the subsequent PRACH resource is within a subsequent instance of the first time period.

In some examples, at 625, the UE 115-c may determine, based on the uplink transmission being a repetition of a plurality of repetitions of an uplink shared channel transmission or an uplink control channel, to postpone performance of the uplink transmission until an available resource in a subsequent instance of the first time period. In such examples, at 630, the network entity 105-b may determine, based on the uplink transmission being a repetition of a plurality of repetitions of an uplink shared channel transmission or an uplink control channel, to postpone monitoring for the uplink transmission until an available resource in a subsequent instance of the first time period.

In some examples, at 635, the UE 115-c may perform the uplink transmission via the first band based on determining to perform the uplink transmission at 625. In such examples, the UE 115-c may refrain from switching to communication in accordance with the second band during the instance of the second time period based on the determining to perform the uplink transmission. Similarly, at 640, the network entity 105-b may monitor for the uplink transmission via the first band based on determining to monitor for the uplink transmission. In such examples, the network entity 105-b may refrain from scheduling communication with the UE 115-c in accordance with the second band during the instance of the second time period based on the determining to monitor for the uplink transmission.

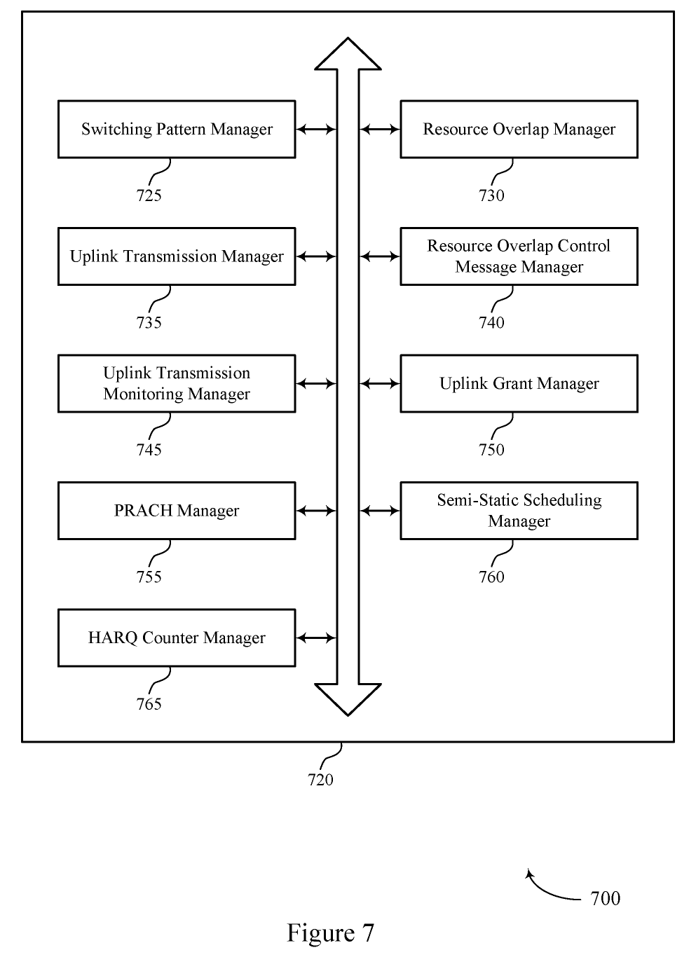

FIG. 7 shows an example of a processing system 720 that supports techniques for handling uplink transmission in a time period associated with downlink communication in accordance with a periodic switching pattern. A processing system 720 may be an example of a processing system 140 (such as of a UE 115) and may include a switching pattern manager 725, a resource overlap manager 730, an uplink transmission manager 735, a resource overlap control message manager 740, an uplink transmission monitoring manager 745, an uplink grant manager 750, a PRACH manager 755, a semi-static scheduling manager 760, an HARQ counter manager 765, or any combination thereof. A processing system 720, or various component thereof, may be an example of means for performing (such as a means for causing a UE 115 to perform) various techniques described herein.

The switching pattern manager 725 may be configured to cause the UE 115 to receive a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication. The resource overlap manager 730 may be configured to cause the UE 115 to determine a resource scheduled for uplink transmission at least partially overlaps in time with an instance of the second time period associated with communications via the second band. The uplink transmission manager 735 may be configured to cause the UE 115 to determine whether to perform an uplink transmission in the resource based on a transmission type of the uplink transmission or a resource type of the resource.

In some examples, the resource overlap control message manager 740 may be configured to cause the UE 115 to receive a control message that indicates whether to perform any uplink transmission of a first uplink transmission type that at least partially overlaps in time with any instance of the second time period, where determining whether to perform the uplink transmission is in accordance with the control message.

In some examples, to support receiving the control message, the semi-static scheduling manager 760 may be configured to cause the UE 115 to receive, via the control message, scheduling information for a set of semi-statically configured resources associated with uplink transmissions of the first uplink transmission type.

In some examples, the uplink grant manager 750 may be configured to cause the UE 115 to receive an uplink grant that schedules the uplink transmission in the resource, where the uplink grant indicates that the transmission type of the uplink transmission is the first uplink transmission type.

In some examples, to support determining whether to perform the uplink transmission, the uplink transmission manager 735 may be configured to cause the UE 115 to determine to drop the uplink transmission based on the transmission type of the uplink transmission being a semi-statically configured uplink transmission.

In some examples, to support determining whether to perform the uplink transmission, the uplink transmission monitoring manager 745 may be configured to cause the UE 115 to determine to perform the uplink transmission based on the resource type of the resource being a resource type common to multiple UEs including the UE.

In some examples, to support determining whether to perform the uplink transmission, the uplink transmission monitoring manager 745 may be configured to cause the UE 115 to determine to drop the uplink transmission based on the transmission type of the uplink transmission being a CG type uplink transmission.

In some examples, the HARQ counter manager 765 may be configured to cause the UE 115 to increment an HPID counter associated with the dropped CG type uplink transmission.

In some examples, the HARQ counter manager 765 may be configured to cause the UE 115 to skip incrementing an HPID counter associated with the dropped CG type uplink transmission.

In some examples, the uplink grant manager 750 may be configured to cause the UE 115 to receive an uplink grant that schedules the uplink transmission in the resource, where the uplink grant indicates a priority level associated with the uplink transmission, and where the transmission type of the uplink transmission includes the priority level.

In some examples, the PRACH manager 755 may be configured to cause the UE 115 to receive a PDCCH order that triggers a PRACH transmission in the resource, where the resource is one of a set of PRACH resources, where determining whether to perform the uplink transmission includes determining to perform the PRACH transmission in the resource based on the transmission type of the uplink transmission being the PRACH transmission.

In some examples, the PRACH manager 755 may be configured to cause the UE 115 to receive a PDCCH order that triggers a PRACH transmission in the resource, where the resource is one of a set of PRACH resources, where determining whether to perform the uplink transmission includes determining to drop the PRACH transmission in the resource based on the transmission type of the uplink transmission being the PRACH transmission. In some examples, the uplink transmission manager 735 may be configured to cause the UE 115 to perform the PRACH transmission in a subsequent PRACH resource of the set of PRACH resources, where the subsequent PRACH resource is within a subsequent instance of the first time period.

In some examples, to support determining whether to perform the uplink transmission in the resource, the uplink transmission manager 735 may be configured to cause the UE 115 to determine, based on the uplink transmission being a repetition of a set of multiple repetitions of an uplink shared channel transmission or an uplink control channel, to postpone performance of the uplink transmission until an available resource in a subsequent instance of the first time period.

In some examples, the uplink transmission manager 735 may be configured to cause the UE 115 to perform, based on determining to perform the uplink transmission, the uplink transmission via the first band. In some examples, the switching pattern manager 725 may be configured to cause the UE 115 to refrain from switching to communication in accordance with the second band during the instance of the second time period based on the determining to perform the uplink transmission.

A processing system 720 may include or be a component of one or more chips, systems-on-chips (SoCs), chipsets, packages, components, or devices that individually or collectively constitute or include a processing system. A processing system 720 may interface with other components of a processing system 720. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a processing system 720).

By including or configuring a processing system 720 for operation in a processing system 720 as described herein, the processing system 720 may support techniques for reduced processing, reduced power consumption, and more efficient utilization of communication resources.

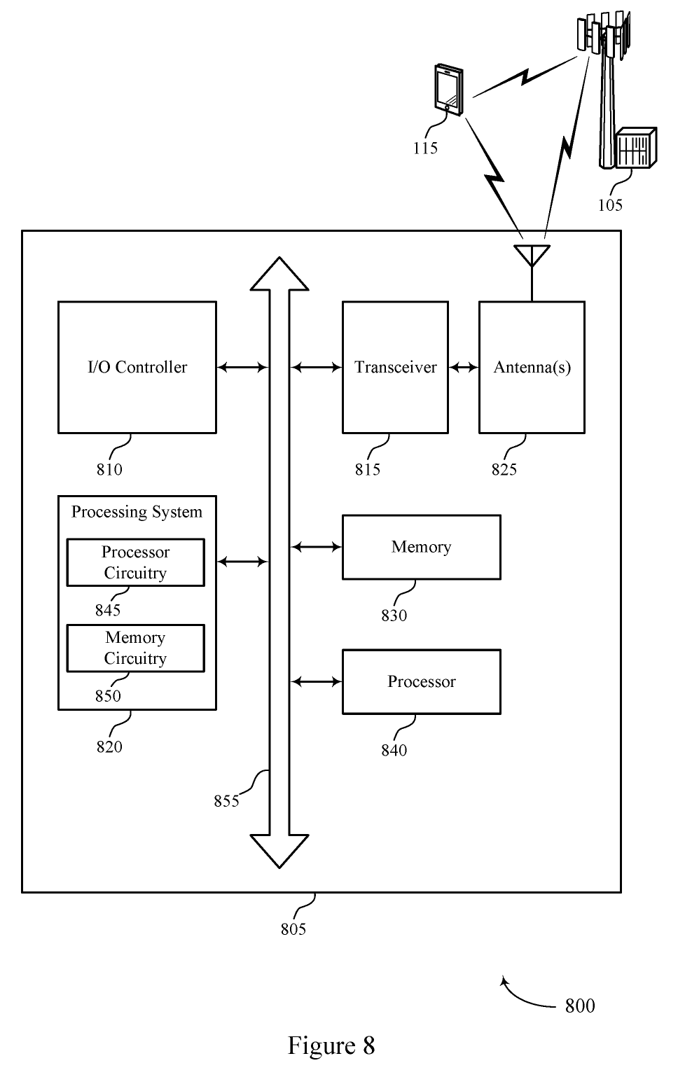

FIG. 8 shows an example of a system 800 including a device 805 that supports techniques for handling uplink transmission in a time period associated with downlink communication in accordance with a periodic switching pattern. The device 805 may be an example of or include components of UE 115. The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

The processing system 820 may be an example of a processing system 140 or a processing system 700. For example, the processing system 820 may include processor circuitry 845 and memory circuitry 850 that stores code, and may be configured to cause the device 805 to perform operations that support techniques for handling uplink transmission in a time period associated with downlink communication in accordance with a periodic switching pattern. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, may support techniques for improved communication reliability, more efficient utilization of communication resources, improved coordination between devices, and improved utilization of processing capability.

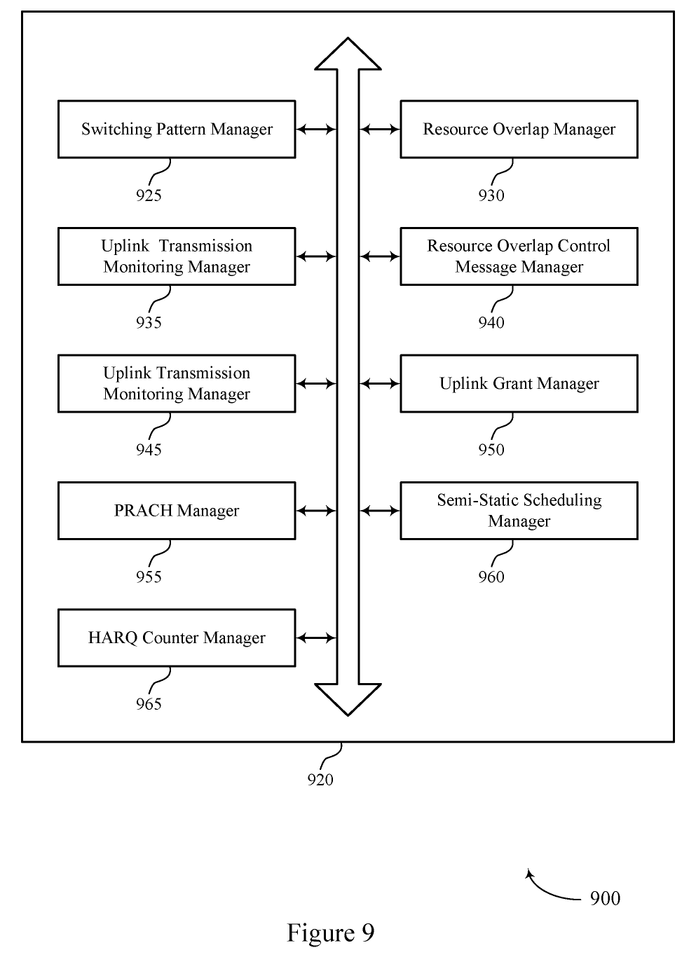

FIG. 9 shows an example of a processing system 920 that supports techniques for handling uplink transmission in a time period associated with downlink communication in accordance with a periodic switching pattern. A processing system 920 may be an example of a processing system 145 (such as network entity 105) and may include a switching pattern manager 925, a resource overlap manager 930, an uplink transmission monitoring manager 935, a resource overlap control message manager 940, an uplink transmission monitoring manager 945, an uplink grant manager 950, a PRACH manager 955, a semi-static scheduling manager 960, an HARQ counter manager 965, or any combination thereof. A processing system 920, or various component thereof, may be an example of means for performing (such as a means for causing a network entity 105 to perform) various techniques described herein.

The switching pattern manager 925 may be configured to cause the network entity 105 to output, for a UE, a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication. The resource overlap manager 930 may be configured to cause the network entity 105 to determine a resource scheduled for uplink transmission for the UE that at least partially overlaps in time with an instance of the second time period associated with communication via the second band. The uplink transmission monitoring manager 935 may be configured to cause the network entity 105 to determine whether to monitor for an uplink transmission in the resource based on a transmission type of the uplink transmission or a resource type of the resource.

In some examples, the resource overlap control message manager 940 may be configured to cause the network entity 105 to output, for the UE, a control message that indicates whether to perform any uplink transmission of a first uplink transmission type that at least partially overlaps in time with any instance of the second time period, where determining whether to monitor for the uplink transmission is in accordance with the control message.

In some examples, to support outputting the control message, the semi-static scheduling manager 960 may be configured to cause the network entity 105 to output, via the control message, scheduling information for a set of semi-statically configured resources associated with uplink transmissions of the first uplink transmission type.

In some examples, the uplink grant manager 950 may be configured to cause the network entity 105 to output, for the UE, an uplink grant that schedules the uplink transmission in the resource, where the uplink grant indicates that the transmission type of the uplink transmission is the first uplink transmission type.

In some examples, to support determining whether to monitor for the uplink transmission, the uplink transmission monitoring manager 945 may be configured to cause the network entity 105 to determine to drop the uplink transmission based on the transmission type of the uplink transmission being a semi-statically configured uplink transmission.

In some examples, to support determining whether to monitor for the uplink transmission, the uplink transmission monitoring manager 945 may be configured to cause the network entity 105 to determine to monitor for the uplink transmission based on the resource type of the resource being a resource type common to multiple UEs including the UE.

In some examples, to support determining whether to monitor for the uplink transmission, the uplink transmission monitoring manager 945 may be configured to cause the network entity 105 to determine to drop the uplink transmission based on the transmission type of the uplink transmission being a CG type uplink transmission.

In some examples, the HARQ counter manager 965 may be configured to cause the network entity 105 to increment an HPID counter associated with the dropped CG type uplink transmission.

In some examples, the HARQ counter manager 965 may be configured to cause the network entity 105 to skip incrementing an HPID counter associated with the dropped CG type uplink transmission.

In some examples, the uplink grant manager 950 may be configured to cause the network entity 105 to output an uplink grant that schedules the uplink transmission in the resource, where the uplink grant indicates a priority level associated with the uplink transmission, and where the transmission type of the uplink transmission includes the priority level.

In some examples, the PRACH manager 955 may be configured to cause the network entity 105 to output a PDCCH order that triggers a PRACH transmission in the resource, where the resource is one of a set of PRACH resources, where determining whether to monitor for the uplink transmission includes determining to monitor for the PRACH transmission in the resource based on the transmission type of the uplink transmission being the PRACH transmission.

In some examples, the PRACH manager 955 may be configured to cause the network entity 105 to output a PDCCH order that triggers a PRACH transmission in the resource, where the resource is one of a set of PRACH resources, where determining whether to monitor for the uplink transmission includes determining to drop the PRACH transmission in the resource based on the transmission type of the uplink transmission being the PRACH transmission. In some examples, the uplink transmission monitoring manager 945 may be configured to cause the network entity 105 to monitor for the PRACH transmission in a subsequent PRACH resource of the set of PRACH resources, where the subsequent PRACH resource is within a subsequent instance of the first time period.

In some examples, to support determining whether to monitor for the uplink transmission, the uplink transmission monitoring manager 945 may be configured to cause the network entity 105 to determine, based on the uplink transmission being a repetition of a set of multiple repetitions of an uplink shared channel transmission or an uplink control channel, to postpone monitoring for the uplink transmission until an available resource in a subsequent instance of the first time period.

In some examples, the uplink transmission monitoring manager 945 may be configured to cause the network entity 105 to monitor, based on determining to monitor for the uplink transmission, for the uplink transmission via the first band. In some examples, the switching pattern manager 925 may be configured to cause the network entity 105 to refrain from scheduling communication with the UE in accordance with the second band during the instance of the second time period based on the determining to monitor for the uplink transmission.

A processing system 920 may include or be an example of one or more chips, SoCs, chipsets, packages, components, or devices that individually or collectively constitute or include a processing system. A processing system 920 may interface with other components of a network entity 105. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a network entity 105). Operations described herein with reference to the processing system 920, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 920 for operation in a processing system 920 as described herein, the processing system 920 may support techniques for reduced processing, reduced power consumption, and more efficient utilization of communication resources.

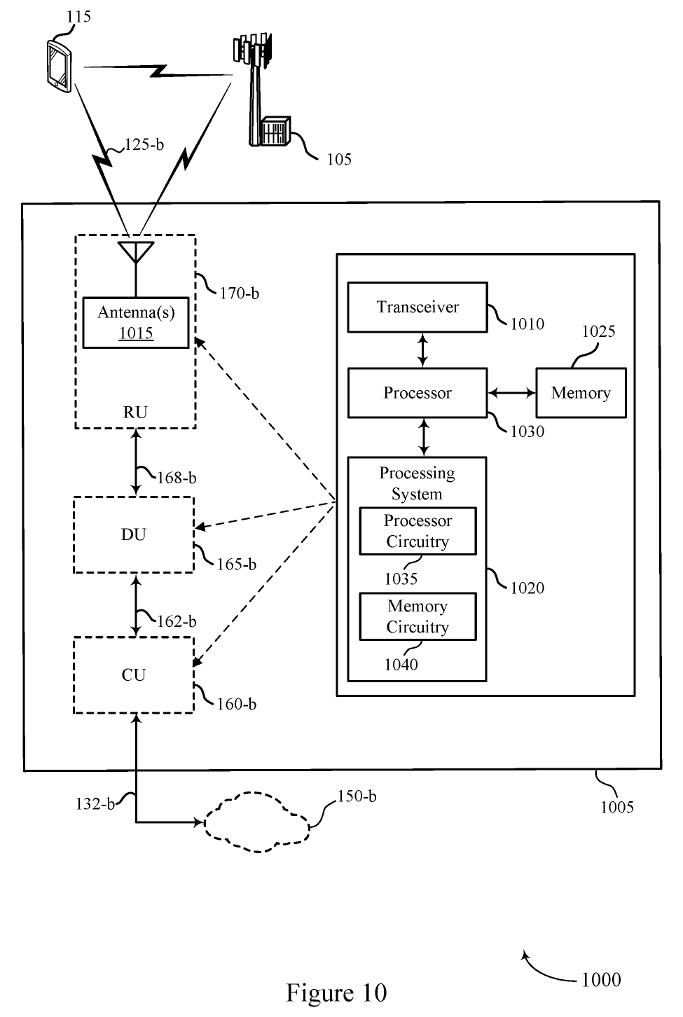

FIG. 10 shows an example of a system 1000 including a device 1005 that supports techniques for handling uplink transmission in a time period associated with downlink communication in accordance with a periodic switching pattern. The device 1005 may communicate (such as via one or more wired interfaces or one or more wireless interfaces) with other network devices or network equipment such as a core network 150-b, other network entities 105, UEs 115, or any combination thereof. The device 1005 may include components for transmitting and receiving communication, which may include a processing system 1020, a transceiver 1010, antenna(s) 1015, a memory 1025, and a processor 1030. Components of the device 1005 may be coupled (such as operatively, communicatively, functionally, electronically, electrically, in electronic communication) via one or more interfaces.

The transceiver 1010 may communicate bi-directionally with another transceiver via wired or wireless links, and may support transmission operations, reception operations, or both, as described herein. The transceiver 1010 may include a modem to modulate and demodulate signals, to provide the modulated signals for transmission (such as via antenna(s) 1015, via a wired interface), and to demodulate received signals (such as received via antenna(s) 1015, received via a wired interface). The transceiver 1010 may be operable to support communication via one or more communication links (such as a communication link 125-b, a backhaul link 132-b, a midhaul link 162-b, fronthaul link 168-b).

The processor 1030 may be a general-purpose processing component that supports various operations (such as applications) of the device 1005. The memory 1025 may be a general-purpose storage component that stores code executable by the processor 1030. Such code may include instructions that, when executed by the processor 1030, cause the device 1005 to perform various functions (such as to support an application of the device 1005).

For examples in which the device 1005 is a network entity 105 in a disaggregated architecture, one or more components of the device 1005 may be located at one or more of a CU 160-b, a DU 165-b, or an RU 170-b, one or more of which may include aspects of the processing system 1020, the processor 1030, the memory 1025, or the transceiver 1010. Functions of the device 1005 may be performed at different components or an operation may be divided between different components (such as different functions being supported by aspects of the CU 160-b, the DU 165-b, or the RU 170-b, the transceiver 1010, the processor 1030, the memory 1025, the processing system 1020, or any combination thereof). For example, the processing system 1020 may be a component of one or more of the CU 160-b, the DU 165-b, or the RU 170-b. In some examples, interfaces between components of device 1005 (such as CU 160-b, DU 165-b, RU 170-b) may support communication at a protocol layer or between protocol layers of a protocol stack.

In some examples, the processing system 1020 may manage aspects of communication with the core network 150-b (such as via a backhaul link 132). For example, the processing system 1020 may manage the transfer of data communication for UEs 115 with a gateway of the core network 150-b. In some examples, the processing system 1020 may manage communication with one or more other network entities 105 and may include a controller or scheduler for controlling communication with UEs 115 (such as in cooperation with the one or more other network entities 105). In some examples, the processing system 1020 may support an interface (such as X2 interface, Xn interface) to provide communication between network entities 105.

The processing system 1020 may be an example of a processing system 145 or a processing system 900. For example, the processing system 1020 may include processor circuitry 1035 and memory circuitry 1040 that stores code, and the processing system 1020 may be configured to cause the device 1005 to perform operations that support techniques for handling uplink transmission in a time period associated with downlink communication in accordance with a periodic switching pattern. Although the processing system 1020 is illustrated as a separate component, which may involve a separate chip, chipset, or other module, in some implementations, one or more functions described with reference to the processing system 1020 may be supported by or performed by a transceiver 1010, antenna(s) 1015, a processor 1030, memory 1025, or any combination thereof, such that a processing system 1020 may include one or more of a transceiver 1010, antenna(s) 1015, a processor 1030, memory 1025, or any combination thereof. Further, processor circuitry 1035 and memory circuitry 1040 each may be implemented at the device 1005 in accordance with an aggregated architecture, or the processor circuitry 1035 and the memory circuitry 1040 may be implemented at one or more of a CU 160-b, a DU 165-b, or an RU 170-b in accordance with a disaggregated architecture.

By including or configuring the processing system 1020 for operation in the device 1005 as described herein, may support techniques for improved communication reliability, more efficient utilization of communication resources, improved coordination between devices, and improved utilization of processing capability.

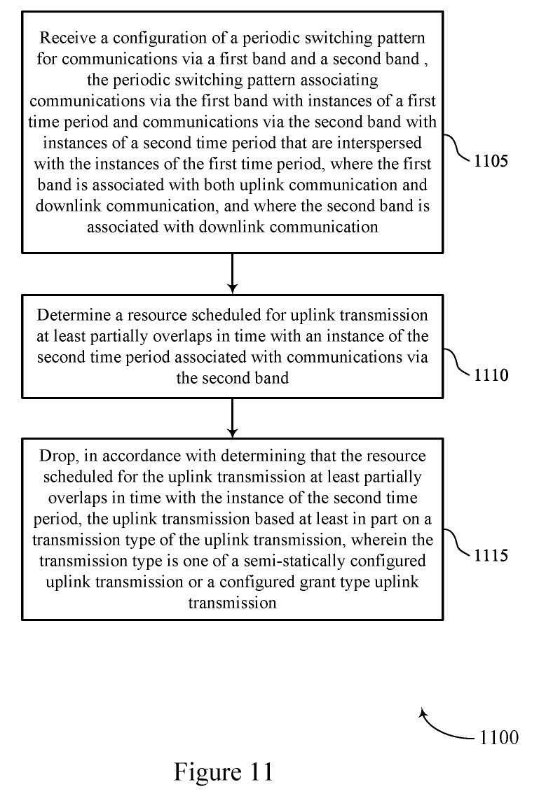

FIG. 11 shows an example of a method 1100 that supports techniques for handling uplink transmission in a time period associated with downlink communication in accordance with a periodic switching pattern. Operations of the method 1100 may be performed by a UE or its components (such as using a processing system configured to cause the UE 115 to perform one or more of the operations) as described herein.

At 1105, the method may include receiving a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication. In some examples, aspects of the operations of 1105 may be performed by a switching pattern manager 725.

At 1110, the method may include determining a resource scheduled for uplink transmission at least partially overlaps in time with an instance of the second time period associated with communications via the second band. In some examples, aspects of the operations of 1110 may be performed by a resource overlap manager 730.

At 1115, the method may include dropping, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission. In some examples, aspects of the operations of 1115 may be performed by an uplink transmission manager 735.

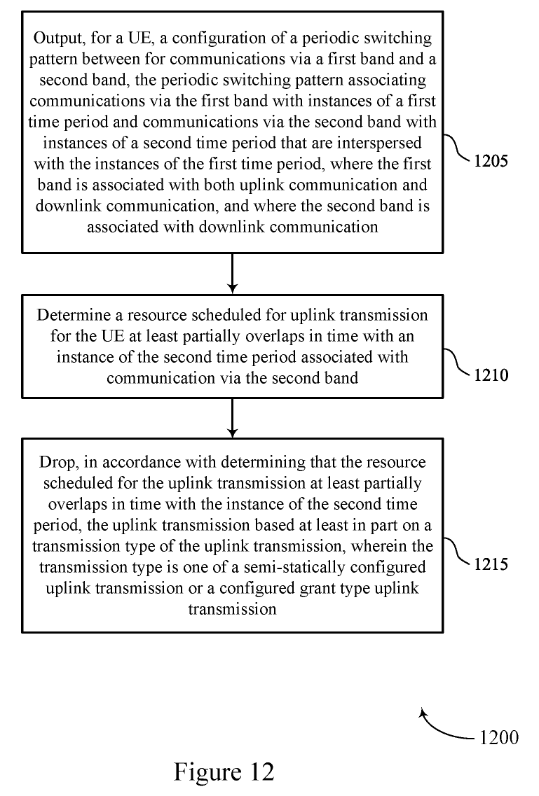

FIG. 12 shows an example of a method 1200 that supports techniques for handling uplink transmission in a time period associated with downlink communication in accordance with a periodic switching pattern. Operations of the method 1200 may be performed by a network entity 105 or its components (such as using a processing system configured to cause the network entity to perform one or more operations) as described herein.

At 1205, the method may include outputting, for a UE, a configuration of a periodic switching pattern for communications via a first band and a second band, the periodic switching pattern associating communications via the first band with instances of a first time period and communications via the second band with instances of a second time period that are interspersed with the instances of the first time period, where the first band is associated with both uplink communication and downlink communication, and where the second band is associated with downlink communication. In some examples, aspects of the operations of 1205 may be performed by a switching pattern manager 925.

At 1210, the method may include determining a resource scheduled for uplink transmission for the UE at least partially overlaps in time with an instance of the second time period associated with communication via the second banddropping, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission. In some examples, aspects of the operations of 1210 may be performed by a resource overlap manager 930.

At 1215, the method may include dropping, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission determining whether to monitor for an uplink transmission in the resource based on a transmission type of the uplink transmission or a resource type of the resource. In some examples, aspects of the operations of 1215 may be performed by an uplink transmission monitoring manager 935.

Aspect 1: A method for wireless communications at a UE, comprising: receiving a configuration of a periodic switching pattern for communications via a first band and a second band, the periodic switching pattern associating communications via the first band with instances of a first time period and communications via the second band with instances of a second time period that are interspersed with the instances of the first time period, wherein the first band is associated with both uplink communication and downlink communication, and wherein the second band is associated with downlink communication; determining a resource scheduled for uplink transmission at least partially overlaps in time with an instance of the second time period associated with communications via the second band; and determining whether to perform an uplink transmission in the resource based at least in part on a transmission type of the uplink transmission or a resource type of the resource.

Aspect 2: The method of aspect 1, further comprising: receiving a control message that indicates whether to perform any uplink transmission of a first uplink transmission type that at least partially overlaps in time with any instance of the second time period, wherein determining whether to perform the uplink transmission is in accordance with the control message.

Aspect 3: The method of aspect 2, wherein receiving the control message comprises: receiving, via the control message, scheduling information for a set of semi-statically configured resources associated with uplink transmissions of the first uplink transmission type.

Aspect 4: The method of aspect 2, further comprising: receiving an uplink grant that schedules the uplink transmission in the resource, wherein the uplink grant indicates that the transmission type of the uplink transmission is the first uplink transmission type.

Aspect 5: The method of any of aspects 1 through 3, wherein determining whether to perform the uplink transmission comprises: determining to drop the uplink transmission based at least in part on the transmission type of the uplink transmission being a semi-statically configured uplink transmission.

Aspect 6: The method of any of aspects 1 through 2, wherein determining whether to perform the uplink transmission comprises: determining to perform the uplink transmission based at least in part on the resource type of the resource being a resource type common to multiple UEs including the UE.

Aspect 7: The method of any of aspects 1 through 3, wherein determining whether to perform the uplink transmission comprises: determining to drop the uplink transmission based at least in part on the transmission type of the uplink transmission being a CG type uplink transmission.

Aspect 8: The method of aspect 7, further comprising: incrementing an HPID counter associated with the dropped CG type uplink transmission.

Aspect 9: The method of aspect 7, further comprising: skipping incrementing an HPID counter associated with the dropped CG type uplink transmission.

Aspect 10: The method of any of aspects 1 through 2 or 4, further comprising: receiving an uplink grant that schedules the uplink transmission in the resource, wherein the uplink grant indicates a priority level associated with the uplink transmission, and wherein the transmission type of the uplink transmission comprises the priority level.

Aspect 11: The method of any of aspects 1 through 2, further comprising: receiving a PDCCH order that triggers a PRACH transmission in the resource, wherein the resource is one of a set of PRACH resources, wherein determining whether to perform the uplink transmission comprises determining to perform the PRACH transmission in the resource based at least in part on the transmission type of the uplink transmission being the PRACH transmission.

Aspect 12: The method of any of aspects 1 through 2, further comprising: receiving a PDCCH order that triggers a PRACH transmission in the resource, wherein the resource is one of a set of PRACH resources, wherein determining whether to perform the uplink transmission comprises determining to drop the PRACH transmission in the resource based at least in part on the transmission type of the uplink transmission being the PRACH transmission; and performing the PRACH transmission in a subsequent PRACH resource of the set of PRACH resources, wherein the subsequent PRACH resource is within a subsequent instance of the first time period.

Aspect 13: The method of any of aspects 1 through 4, wherein determining whether to perform the uplink transmission in the resource comprises: determining, based at least in part on the uplink transmission being a repetition of a plurality of repetitions of an uplink shared channel transmission or an uplink control channel, to postpone performance of the uplink transmission until an available resource in a subsequent instance of the first time period.

Aspect 14: The method of any of aspects 1 through 4, 6, or 11 through 12, further comprising: performing, based at least in part on determining to perform the uplink transmission, the uplink transmission via the first band; and refraining from switching to communication in accordance with the second band during the instance of the second time period based at least in part on the determining to perform the uplink transmission.

Aspect 15: The method of any of aspects 1 through 14 wherein the periodic switching pattern comprises carrier aggregation switching between a first carrier component in the first band configured for FDD and a second carrier component in the second band configured for SDL, wherein the switching occurs at a carrier component level.

Aspect 16: A method for wireless communications at a network entity, comprising: outputting, for a UE, a configuration of a periodic switching pattern for communications via a first band and a second band, the periodic switching pattern associating communications via the first band with instances of a first time period and communications via the second band with instances of a second time period that are interspersed with the instances of the first time period, wherein the first band is associated with both uplink communication and downlink communication, and wherein the second band is associated with downlink communication; determining a resource scheduled for uplink transmission for the UE that at least partially overlaps in time with an instance of the second time period associated with communication via the second band; and determining whether to monitor for an uplink transmission in the resource based at least in part on a transmission type of the uplink transmission or a resource type of the resource.

Aspect 17: The method of aspect 16, further comprising: outputting, for the UE, a control message that indicates whether to perform any uplink transmission of a first uplink transmission type that at least partially overlaps in time with any instance of the second time period, wherein determining whether to monitor for the uplink transmission is in accordance with the control message.

Aspect 18: The method of aspect 17, wherein outputting the control message comprises: outputting, via the control message, scheduling information for a set of semi-statically configured resources associated with uplink transmissions of the first uplink transmission type.

Aspect 19: The method of aspect 17, further comprising: outputting, for the UE, an uplink grant that schedules the uplink transmission in the resource, wherein the uplink grant indicates that the transmission type of the uplink transmission is the first uplink transmission type.

Aspect 20: The method of any of aspects 16 through 18, wherein determining whether to monitor for the uplink transmission comprises: determining to drop the uplink transmission based at least in part on the transmission type of the uplink transmission being a semi-statically configured uplink transmission.

Aspect 21: The method of any of aspects 16 through 17, wherein determining whether to monitor for the uplink transmission comprises: determining to monitor for the uplink transmission based at least in part on the resource type of the resource being a resource type common to multiple UEs including the UE.

Aspect 22: The method of any of aspects 16 through 18, wherein determining whether to monitor for the uplink transmission comprises: determining to drop the uplink transmission based at least in part on the transmission type of the uplink transmission being a CG type uplink transmission.

Aspect 23: The method of aspect 22, further comprising: incrementing an HPID counter associated with the dropped CG type uplink transmission.

Aspect 24: The method of aspect 22, further comprising: skipping incrementing an HPID counter associated with the dropped CG type uplink transmission.

Aspect 25: The method of any of aspects 16 through 17 or 19, further comprising: outputting an uplink grant that schedules the uplink transmission in the resource, wherein the uplink grant indicates a priority level associated with the uplink transmission, and wherein the transmission type of the uplink transmission comprises the priority level.

Aspect 26: The method of any of aspects 16 through 17, further comprising: outputting a PDCCH order that triggers a PRACH transmission in the resource, wherein the resource is one of a set of PRACH resources, wherein determining whether to monitor for the uplink transmission comprises determining to monitor for the PRACH transmission in the resource based at least in part on the transmission type of the uplink transmission being the PRACH transmission.

Aspect 27: The method of any of aspects 16 through 17, further comprising: outputting a PDCCH order that triggers a PRACH transmission in the resource, wherein the resource is one of a set of PRACH resources, wherein determining whether to monitor for the uplink transmission comprises determining to drop the PRACH transmission in the resource based at least in part on the transmission type of the uplink transmission being the PRACH transmission; and monitoring for the PRACH transmission in a subsequent PRACH resource of the set of PRACH resources, wherein the subsequent PRACH resource is within a subsequent instance of the first time period.

Aspect 28: The method of any of aspects 16 through 19, wherein determining whether to monitor for the uplink transmission comprises: determining, based at least in part on the uplink transmission being a repetition of a plurality of repetitions of an uplink shared channel transmission or an uplink control channel, to postpone monitoring for the uplink transmission until an available resource in a subsequent instance of the first time period.

Aspect 29: The method of any of aspects 16 through 19, 21, or 25 through 26, further comprising: monitoring, based at least in part on determining to monitor for the uplink transmission, for the uplink transmission via the first band; and refraining from scheduling communication with the UE in accordance with the second band during the instance of the second time period based at least in part on the determining to monitor for the uplink transmission.

Aspect 30: The method of any of aspects 16 through 30 wherein the periodic switching pattern comprises carrier aggregation switching between a first carrier component in the first band configured for FDD and a second carrier component in the second band configured for SDL, wherein the switching occurs at a carrier component level.

Aspect 31: A UE for wireless communications, comprising a processing system that includes processor circuitry and memory circuitry that stores code, the processing system configured to cause the UE to perform a method of any of aspects 1 through 15.

Aspect 32: A UE for wireless communications, comprising at least one means for performing a method of any of aspects 1 through 15.

Aspect 33: A non-transitory computer-readable medium storing code for wireless communications, the code comprising instructions executable by one or more processors to perform a method of any of aspects 1 through 15.

Aspect 34: A network entity for wireless communications, comprising a processing system that includes processor circuitry and memory circuitry that stores code, the processing system configured to cause the network entity to perform a method of any of aspects 16 through 30.

Aspect 35: A network entity for wireless communications, comprising at least one means for performing a method of any of aspects 16 through 30.

Aspect 36: A non-transitory computer-readable medium storing code for wireless communications, the code comprising instructions executable by one or more processors to perform a method of any of aspects 16 through 30.

Aspect 37: A method for wireless communications at a UE, comprising: receiving a configuration of a periodic switching pattern for communications via a first band and a second band, the periodic switching pattern associating communications via the first band with instances of a first time period and communications via the second band with instances of a second time period that are interspersed with the instances of the first time period, wherein the first band is associated with both uplink communication and downlink communication, and wherein the second band is associated with downlink communication; determining a resource scheduled for uplink transmission at least partially overlaps in time with an instance of the second time period associated with communications via the second band; and dropping, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission.

Aspect 38: The method of aspect , wherein the transmission type is the configured grant type uplink transmission and wherein the method further comprises: incrementing a hybrid automatic repeat request process identifier counter associated with the dropped configured grant type uplink transmission.

Aspect 39: The method of any of aspects 37 through 38, further comprising: receiving a control message that indicates whether to perform any uplink transmission of a first uplink transmission type that at least partially overlaps in time with any instance of the second time period, wherein determination of whether to perform the uplink transmission is in accordance with the control message.

Aspect 40: The method of aspect 39 , wherein receiving the control message comprises: receiving, via the control message, scheduling information for a set of semi-statically configured resources associated with uplink transmissions of the first uplink transmission type.

Aspect 41: The method of any of aspects 39 through 40, further comprising: receiving an uplink grant that schedules the uplink transmission in the resource, wherein the uplink grant indicates that the transmission type of the uplink transmission is the first uplink transmission type.

Aspect 42: The method of any of aspects 37 through 41, further comprising: determining, based at least in part on the uplink transmission being a repetition of a plurality of repetitions of an uplink shared channel transmission or an uplink control channel, to postpone performance of the uplink transmission until an available resource in a subsequent instance of the first time period.

Aspect 43: The method of any of aspects 37 through 42, wherein the periodic switching pattern comprises carrier aggregation switching between a first carrier component in the first band configured for FDD and a second carrier component in the second band configured for supplementary downlink (SDL), the switching occurs at a carrier component level in the carrier aggregation configuration.

Aspect 44: A method for wireless communications at a network entity, comprising: outputting, for a UE, a configuration of a periodic switching pattern between for communications via a first band and a second band, the periodic switching pattern associating communications via the first band with instances of a first time period and communications via the second band with instances of a second time period that are interspersed with the instances of the first time period, wherein the first band is associated with both uplink communication and downlink communication, and wherein the second band is associated with downlink communication; determining a resource scheduled for uplink transmission for the UE that at least partially overlaps in time with an instance of the second time period associated with communication via the second band; and dropping, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission.

Aspect 45: The method of aspect 44, wherein the transmission type is the configured grant type uplink transmission and wherein the method further comprises: incrementing a hybrid automatic repeat request process identifier counter associated with the dropped configured grant type uplink transmission.

Aspect 46: The method of any of aspects 44 through 45, further comprising: outputting, for the UE, a control message that indicates whether to perform any uplink transmission of a first uplink transmission type that at least partially overlaps in time with any instance of the second time period, wherein determination of whether to monitor for the uplink transmission is in accordance with the control message.

Aspect 47: The method of aspect 46, wherein outputting the control message comprises: outputting, via the control message, scheduling information for a set of semi-statically configured resources associated with uplink transmissions of the first uplink transmission type.

Aspect 48: The method of any of aspects 46 through 47, further comprising: outputting, for the UE, an uplink grant that schedules the uplink transmission in the resource, wherein the uplink grant indicates that the transmission type of the uplink transmission is the first uplink transmission type.

Aspect 49: The method of any of aspects 44 through 48, further comprising: determining, based at least in part on the uplink transmission being a repetition of a plurality of repetitions of an uplink shared channel transmission or an uplink control channel, to postpone performance of the uplink transmission until an available resource in a subsequent instance of the first time period.

Aspect 50: The method of any of aspects 44 through 49, wherein the periodic switching pattern comprises carrier aggregation switching between a first carrier component in the first band configured for FDD and a second carrier component in the second band configured for supplementary downlink (SDL), the switching occurs at a carrier component level.

Aspect 51: A UE for wireless communications, comprising a processing system that includes processor circuitry and memory circuitry that stores code, the processing system configured to cause the UE to perform a method of any of aspects 37 through 43.

Aspect 52: A UE for wireless communications, comprising at least one means for performing a method of any of aspects 37 through 43.

Aspect 53: A non-transitory computer-readable medium storing code for wireless communications, the code comprising instructions executable by one or more processors to perform a method of any of aspects 37 through 43.

Aspect 54: A network entity for wireless communications, comprising a processing system that includes processor circuitry and memory circuitry that stores code, the processing system configured to cause the network entity to perform a method of any of aspects 44 through 50.

Aspect 55: A network entity for wireless communications, comprising at least one means for performing a method of any of aspects 44 through 50.

Aspect 56: A non-transitory computer-readable medium storing code for wireless communications, the code comprising instructions executable by one or more processors to perform a method of any of aspects 44 through 50.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a configuration of a periodic switching pattern for communications via a first band and a second band, the periodic switching pattern associating communications via the first band with instances of a first time period and communications via the second band with instances of a second time period that are interspersed with the instances of the first time period, wherein the first band is associated with both uplink communication and downlink communication, and wherein the second band is associated with downlink communication;
determine a resource scheduled for uplink transmission at least partially overlaps in time with an instance of the second time period associated with communications via the second band; and
drop, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission.

2. The UE of claim 1, wherein the transmission type is the configured grant type uplink transmission and wherein the processing system is further configured to cause the UE to:
increment a hybrid automatic repeat request process identifier counter associated with the dropped configured grant type uplink transmission.

3. The UE of claim 1, wherein the processing system is further configured to cause the UE to:
receive a control message that indicates whether to perform any uplink transmission of a first uplink transmission type that at least partially overlaps in time with any instance of the second time period, wherein determination of whether to perform the uplink transmission is in accordance with the control message.

4. The UE of claim 3, wherein, to receive the control message, the processing system is configured to cause the UE to:
receive, via the control message, scheduling information for a set of semi-statically configured resources associated with uplink transmissions of the first uplink transmission type.

5. The UE of claim 3, wherein the processing system is further configured to cause the UE to:
receive an uplink grant that schedules the uplink transmission in the resource, wherein the uplink grant indicates that the transmission type of the uplink transmission is the first uplink transmission type.

6. The UE of claim 1, wherein the processing system is further configured to cause the UE to:
determine, based at least in part on the uplink transmission being a repetition of a plurality of repetitions of an uplink shared channel transmission or an uplink control channel, to postpone performance of the uplink transmission until an available resource in a subsequent instance of the first time period.

7. The UE of claim 1, wherein the periodic switching pattern comprises carrier aggregation switching between a first carrier component in the first band configured for frequency division duplexing (FDD) and a second carrier component in the second band configured for supplementary downlink (SDL), wherein the switching occurs at a carrier component level.

8. A network entity, comprising:
a processing system that includes processor circuitry and memory circuitry that stores code, the processing system configured to cause the network entity to:
output, for a user equipment (UE), a configuration of a periodic switching pattern between for communications via a first band and a second band, the periodic switching pattern associating communications via the first band with instances of a first time period and communications via the second band with instances of a second time period that are interspersed with the instances of the first time period, wherein the first band is associated with both uplink communication and downlink communication, and wherein the second band is associated with downlink communication;
determine a resource scheduled for uplink transmission for the UE that at least partially overlaps in time with an instance of the second time period associated with communication via the second band; and
drop, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission.

9. The network entity of claim 8, wherein the transmission type is the configured grant type uplink transmission and wherein the processing system is further configured to cause the network entity to:
increment a hybrid automatic repeat request process identifier counter associated with the dropped configured grant type uplink transmission.

10. The network entity of claim 8, wherein the processing system is further configured to cause the network entity to:
output, for the UE, a control message that indicates whether to perform any uplink transmission of a first uplink transmission type that at least partially overlaps in time with any instance of the second time period, wherein determination of whether to monitor for the uplink transmission is in accordance with the control message.

11. The network entity of claim 10, wherein, to output the control message, the processing system is configured to cause the network entity to:
output, via the control message, scheduling information for a set of semi-statically configured resources associated with uplink transmissions of the first uplink transmission type.

12. The network entity of claim 10, wherein the processing system is further configured to cause the network entity to:
output, for the UE, an uplink grant that schedules the uplink transmission in the resource, wherein the uplink grant indicates that the transmission type of the uplink transmission is the first uplink transmission type.

13. The network entity of claim 8, wherein the processing system is further configured to cause the network entity to:
determine, based at least in part on the uplink transmission being a repetition of a plurality of repetitions of an uplink shared channel transmission or an uplink control channel, to postpone monitoring for the uplink transmission until an available resource in a subsequent instance of the first time period.

14. The network entity of claim 8, wherein the periodic switching pattern comprises carrier aggregation switching between a first carrier component in the first band configured for frequency division duplexing (FDD) and a second carrier component in the second band configured for supplementary downlink (SDL), wherein the switching occurs at a carrier component level.

15. A method for wireless communications at a user equipment (UE), comprising:
receiving a configuration of a periodic switching pattern for communications via a first band and a second band, the periodic switching pattern associating communications via the first band with instances of a first time period and communications via the second band with instances of a second time period that are interspersed with the instances of the first time period, wherein the first band is associated with both uplink communication and downlink communication, and wherein the second band is associated with downlink communication;
determining a resource scheduled for uplink transmission at least partially overlaps in time with an instance of the second time period associated with communications via the second band; and
dropping, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission.

16. The method of claim 15, wherein the transmission type is the configured grant type uplink transmission and wherein the method further comprises:
incrementing a hybrid automatic repeat request process identifier counter associated with the dropped configured grant type uplink transmission.

17. The method of claim 15, further comprising:
receiving a control message that indicates whether to perform any uplink transmission of a first uplink transmission type that at least partially overlaps in time with any instance of the second time period, wherein determination of whether to perform the uplink transmission is in accordance with the control message.

18. The method of claim 17, wherein receiving the control message comprises:
receiving, via the control message, scheduling information for a set of semi-statically configured resources associated with uplink transmissions of the first uplink transmission type.

19. The method of claim 17, further comprising:
receiving an uplink grant that schedules the uplink transmission in the resource, wherein the uplink grant indicates that the transmission type of the uplink transmission is the first uplink transmission type.

20. The method of claim 15, further comprising:
determining, based at least in part on the uplink transmission being a repetition of a plurality of repetitions of an uplink shared channel transmission or an uplink control channel, to postpone performance of the uplink transmission until an available resource in a subsequent instance of the first time period.

21. The method of claim 15, wherein the periodic switching pattern comprises carrier aggregation switching between a first carrier component in the first band configured for frequency division duplexing (FDD) and a second carrier component in the second band configured for supplementary downlink (SDL), wherein the switching occurs at a carrier component level in the carrier aggregation configuration.

22. A method for wireless communications at a network entity, comprising:
outputting, for a user equipment (UE), a configuration of a periodic switching pattern for communications via a first band and a second band, the periodic switching pattern associating communications via the first band with instances of a first time period and communications via the second band with instances of a second time period that are interspersed with the instances of the first time period, wherein the first band is associated with both uplink communication and downlink communication, and wherein the second band is associated with downlink communication;
determining a resource scheduled for uplink transmission for the UE that at least partially overlaps in time with an instance of the second time period associated with communication via the second band; and
dropping, in accordance with determining that the resource scheduled for the uplink transmission at least partially overlaps in time with the instance of the second time period, the uplink transmission based at least in part on a transmission type of the uplink transmission, wherein the transmission type is one of a semi-statically configured uplink transmission or a configured grant type uplink transmission.

23. The method of claim 22, wherein the transmission type is the configured grant type uplink transmission and wherein the method further comprises:
incrementing a hybrid automatic repeat request process identifier counter associated with the dropped configured grant type uplink transmission.

24. The method of claim 22, further comprising:
outputting, for the UE, a control message that indicates whether to perform any uplink transmission of a first uplink transmission type that at least partially overlaps in time with any instance of the second time period, wherein determination of whether to monitor for the uplink transmission is in accordance with the control message.

25. The method of claim 24, wherein outputting the control message comprises:
outputting, via the control message, scheduling information for a set of semi-statically configured resources associated with uplink transmissions of the first uplink transmission type.

26. The method of claim 24, further comprising:
outputting, for the UE, an uplink grant that schedules the uplink transmission in the resource, wherein the uplink grant indicates that the transmission type of the uplink transmission is the first uplink transmission type.

27. The method of claim 22, further comprising:
determining, based at least in part on the uplink transmission being a repetition of a plurality of repetitions of an uplink shared channel transmission or an uplink control channel, to postpone performance of the uplink transmission until an available resource in a subsequent instance of the first time period.

28. The method of claim 22, wherein the periodic switching pattern comprises carrier aggregation switching between a first carrier component in the first band configured for frequency division duplexing (FDD) and a second carrier component in the second band configured for supplementary downlink (SDL), wherein the switching occurs at a carrier component level.
